(19) United States
(12) Patent Application Publication
(10) Pub. No.: US 2016/0089566 A1
(43) Pub. Date: Mar. 31, 2016

(54) SENSOR, MOTION MEASUREMENT SYSTEM, AND METHOD OF MOTION MEASUREMENT

(71) Applicant: SEIKO EPSON CORPORATION, Tokyo (JP)

(72) Inventors: Shinichi MITSUNAGA, Suwa-shi (JP); Kazuhiro SHIBUYA, Shiojiri-shi (JP)

(21) Appl. No.: 14/847,563

(22) Filed: Sep. 8, 2015

(30) Foreign Application Priority Data
Sep. 26, 2014 (JP) 2014-197267

(51) Int. Cl. A63B 24/00; G01P 1/00

(52) U.S. Cl. CPC A63B 24/0003; G01P 1/00

(57) ABSTRACT

A sensor unit includes: a measuring unit; a first buffer which saves measured data measured by the measuring unit when outputting the measured data outside; a second buffer; and an output mode switching unit which switches an output mode for outputting the measured data outside. The output mode includes a real-time mode (first mode) in which the first buffer is overwritten with the measured data if there is no free space in the first buffer, and a buffering mode (second mode) in which the measured data is written in the second buffer if there is no free space in the first buffer and in which the measured data written in the second buffer is transferred to the first buffer if a free space is generated in the first buffer.

### BACKGROUND

1. Technical Field

The present invention relates to a sensor, a motion measurement system, and a method of motion measurement.

2. Related Art

JP-A-2008-73210 discloses a technique in which swing motion is measured on the basis of outputs from a three-axis acceleration sensor and a three-axis gyro sensor, which are inertial sensors, installed on a golf club. According to the technique of JP-A-2008-73210, the amount of calculation can be significantly reduced, compared with the case where image processing of a video of a swing filmed with a camera is carried out to analyze the swing. Also, according to the technique of JP-A-2008-73210, since a large device such as a camera is not necessary, there are few constraints on the place where the user performs a swing.

In measuring a swing motion using an output from a sensor, there are cases where the user is made to become stationary for a few seconds before starting a swing and where a computing device carries out calibration to obtain a zero-point bias value of the sensor output, using the sensor output during the stationary period of the user. In order to accurately measure a swing motion, a higher sampling rate of the sensor is better. However, the volume of data transmitted from the sensor to the computing device becomes greater as the sampling rate of the sensor becomes higher. Consequently, it takes longer for the computing device to detect the stationary period of the user in the calibration, and the user has to remain stationary until the computing device detects the stationary period. This raises the problem of deteriorating convenience. Such a problem occurs not only with a swing motion in golf but also with any motion.

### SUMMARY

An advantage of some aspects of the invention is to provide a sensor that can be used for reducing the time required for detecting a stationary period of a measurement target, and a motion measurement system and a method of motion measurement that can reduce the time required for detecting a stationary period of a measurement target, using the sensor.

The invention can be implemented as the following forms or application examples.

### Application Example 1

A sensor according to this application example includes: a measuring unit; a first buffer which saves measured data measured by the measuring unit when outputting the measured data outside; a second buffer; and an output mode switching unit which switches an output mode for outputting the measured data outside. The output mode includes a first mode in which the first buffer is overwritten with the measured data if there is no free space in the first buffer, and a second mode in which the measured data is written in the second buffer if there is no free space in the first buffer and in which the measured data written in the second buffer is transferred to the first buffer if a free space is generated in the first buffer.

The sensor according to this application example may be, for example, an inertial sensor. The inertial sensor may be, for example, an acceleration sensor, an angular velocity sensor, or a sensor unit having an acceleration sensor and an angular velocity sensor.

In the sensor according to this application example, in the first mode, a part of the measured data may be destroyed and may not be outputted. However, the output delay of the measured data can be reduced securely. Also, since the measured data only has small variation during a stationary period when there is little motion of the measurement target, even if a part of the measured data is destroyed, the stationary period can be detected on the basis of the remaining part of the measured data. Therefore, by being set in the first mode during the stationary period of the measurement target, the sensor according to this application example can be used in reducing the time required for detecting the stationary period.

Also, in the sensor according to this application example, in the second mode, all of the measured data can be outputted without being destroyed, even if the output delay increases. Therefore, by being set in the second mode during the motion period of the measurement target, the sensor according to this application example can be used in motion analysis of the measurement target.

### Application Example 2

In the sensor according to the application example, the output mode switching unit may switch the output mode on the basis of a switch signal inputted from outside.

According to this application example, the output mode of the sensor can be controlled from outside.

### Application Example 3

In the sensor according to the application example, the output mode switching unit may switch the output mode on the basis of the measured data.

The sensor according to this application example can switch the output mode autonomously.

### Application Example 4

A motion measurement system according to this application example includes a sensor and a computing device. The sensor includes: a measuring unit; a first buffer which saves measured data measured by the measuring unit when outputting the measured data outside; a second buffer; and an output mode switching unit which switches an output mode for outputting the measured data outside. The output mode includes a first mode in which the first buffer is overwritten with the measured data if there is no free space in the first buffer, and a second mode in which the measured data is written in the second buffer if there is no free space in the first buffer and in which the measured data written in the second buffer is transferred to the first buffer if a free space is generated in the first buffer. The computing device includes: a stationary period detection unit which detects a stationary period during which a measurement target is stationary, on the basis of first measured data outputted from the sensor in the first mode; and a sensor control unit which transmits, to the sensor, a first switch signal instructing the sensor to switch to the second mode, if the stationary period detection unit detects the stationary period.

The measurement target may be, for example, a piece of sports equipment on which the sensor according to this application example is installed (for example, equipment such as a golf club, tennis racket, baseball bat, or hockey stick), a user using this sports equipment, or a user on which the sensor according to this application example is installed.

In the motion measurement system according to this application example, in the sensor in the first mode, a part of the measured data may be destroyed and may not be outputted. However, the output delay of the measured data can be reduced securely. Also, since the measured data only has small variation during a stationary period when there is little motion of the measurement target, even if a part of the measured data is destroyed, the computing device can detect the stationary period on the basis of the remaining part of the first measured data. Therefore, in the motion measurement system according to this application example, the computing device can reduce the time required for detecting the stationary period, by having the sensor set in the first mode during the stationary period of the measurement object.

In the motion measurement system according to this application example, the sensor in the second mode can output all of the measured data without destroying the measured data, even if the output delay increases. Therefore, in the motion measurement system according to this application example, the computing device can analyze the motion of the measurement target, using the measured data after the stationary period is detected.

### Application Example 5

In the motion measurement system according to the application example, the stationary period detection unit in the computing device may detect the stationary period if the first measured data is within a predetermined range at a predetermined time.

### Application Example 6

In the motion measurement system according to the application example, the computing device may include a zero-point bias value calculation unit which calculates a zero-point bias value of the measured data from the sensor if the stationary period detection unit detects the stationary period.

For example, the zero-point bias value calculation unit may calculate an average value of the measured data in the stationary period and regard the average value as the zero-point bias value.

### Application Example 7

In the motion measurement system according to the application example, the computing device may include a motion analysis unit which analyzes a motion of the measurement target, using second measured data outputted from the sensor in the second mode.

In the motion measurement system according to this application example, the computing device can acquire a sufficient volume of second measured data in the motion period of the measurement target and therefore can accurately analyze the motion of the measurement target.

### Application Example 8

In the motion measurement system according to the application example, the computing device may include a motion end detection unit which detects an end of the motion of the measurement target. The sensor control unit may transmit, to the sensor, a second switch signal instructing the sensor to switch to the first mode, if the motion end detection unit detects the end of the motion of the measurement target.

### Application Example 9

In the motion measurement system according to the application example, the sensor may include a sampling rate switching unit which switches a sampling rate at which the measuring unit carries out measurement. In the computing device, the stationary period detection unit may detect the stationary period on the basis of the first measured data measured at a first sampling rate and outputted in the first mode by the sensor. The sensor control unit may transmit, to the sensor, the first switching signal instructing the sensor to switch to a second sampling rate and switch to the second mode, if the stationary period detection unit detects the stationary period. The first sampling rate may be lower than the second sampling rate.

For example, the first sampling rate may be equal to or below an output rate at which the sensor outputs the measured data, and the second sampling rate may be above the output rate at which the sensor outputs the measured data. For example, the first sampling rate may be 250 Hz or below and the second sampling rate may be 1 kHz or above.

In the motion measurement system according to this application example, the sensor can reduce the volume of the first measured data by carrying out measurement in the stationary period of the measurement target at the first sampling rate that is lower than the second sampling rate in the subsequent period. Therefore, the computing device can more securely reduce the time required for detecting the stationary period of the measurement target on the basis of the first measured data.

### Application Example 10

In the motion measurement system according to the application example, the sensor control unit in the computing device may transmit, to the sensor, the second switch signal instructing the sensor to switch to the first mode and switch to the first sampling rate, if the motion end detection unit detects the end of the motion of the measurement target.

In the motion measurement system according to this application example, the volume of the measured data from the sensor can be reduced after the end of the motion of the measurement target.

### Application Example 11

A method of motion measurement according to this application example includes: causing a sensor to output first measured data in a first mode, in a stationary period of a measurement target; and causing the sensor to output second measured data in a second mode, in a motion period of the measurement target. The first mode is a mode in which, if there is no free space in a first buffer for saving the measured data when outputting the measured data outside, the first buffer is overwritten with the measured data. The second mode is a mode in which the measured data is written in a second buffer if there is no free space in the first buffer and in which the measured data written in the second buffer is transferred to the first buffer if a free space is generated in the first buffer.

The motion period of the measurement target may be, for example, a period during which a user performs a swing using sports equipment.

In the method of motion measurement according to this application example, the sensor can securely reduce the output delay of the first measured data in the stationary period of the measurement target. Also, since the measured data only has small variation during the stationary period when there is little motion of the measurement target, even if a part of the first measured data is destroyed, the stationary period can be detected on the basis of the remaining part of the first measured data. Therefore, in the method of motion measurement according to this application example, the time required for detecting the stationary period can be reduced by detecting the stationary period of the measurement target on the basis of the first measured data.

Also, in the method of motion measurement according to this application example, in the motion period of the measurement target, the sensor can output all of the second measured data without destroying the second measured data, even if the output delay increases. Therefore, in the method of motion measurement according to this application example, the motion of the measurement target can be analyzed on the basis of the second measured data.

### Application Example 12

A method of motion measurement according to this application example includes: causing a sensor to output first measured data in a first mode, in a stationary period of a measurement target; causing a computing device to detect the stationary period during which the measurement target is stationary, on the basis of the first measured data; causing the computing device to transmit, to the sensor, a first switch signal instructing the sensor to switch to a second mode, if the stationary period is detected; causing the sensor to switch the output mode to the second mode on the basis of the first switch signal; and causing the sensor to output second measured data in the second mode. The first mode is a mode in which, if there is no free space in a first buffer for saving the measured data when outputting the measured data outside, the first buffer is overwritten with the measured data. The second mode is a mode in which the measured data is written in a second buffer if there is no free space in the first buffer and in which the measured data written in the second buffer is transferred to the first buffer if a free space is generated in the first buffer.

In the method of motion measurement according to this application example, the sensor can securely reduce the output delay of the first measured data in the stationary period of the measurement target. Also, since the measured data only has small variation during the stationary period when there is little motion of the measurement target, even if a part of the first measured data is destroyed, the computing device can detect the stationary period on the basis of the remaining part of the first measured data. Therefore, in the method of motion measurement according to this application example, the computing device can reduce the time required for detecting the stationary period.

Also, in the method of motion measurement according to this application example, in the motion period of the measurement target, the sensor can output all of the second measured data without destroying the second measured data, even if the output delay increases. Therefore, in the method of motion measurement according to this application example, the computing device can analyze the motion of the measurement target on the basis of the second measured data.

### Application Example 13

In the method of motion measurement according to the application example, in the causing a computing device to detect the stationary period, the computing device may detect the stationary period if the first measured data is within a predetermined range at a predetermined time.

### Application Example 14

The method of motion measurement according to the application example may include causing the computing device to calculate a zero-point bias value of the measured data from the sensor if the stationary period is detected.

### Application Example 15

The method of motion measurement according to the application example may include causing the computing device to analyze the motion of the measurement target, using the second measured data.

In the method of motion measurement according to this application example, the computing device can acquire a sufficient volume of second measured data in the motion period of the measurement target and therefore can accurately analyze the motion of the measurement target.

### Application Example 16

The method of motion measurement according to the application example may include: causing the computing device to detect an end of the motion of the measurement target; and causing the computing device to transmit, to the sensor, a second switch signal instructing the sensor to switch to the first mode, if the end of the motion of the measurement target is detected.

### Application Example 17

The method of motion measurement according to the application example may include causing the sensor to switch the output mode to the second mode on the basis of the second switch signal.

### BRIEF DESCRIPTION OF THE DRAWINGS

The invention will be described with reference to the accompanying drawings, wherein like numbers reference like elements.

FIG. 1 is an explanatory view showing an outline of a motion measurement system according to an embodiment.

FIG. 2 shows an example of the position of installation and direction of a sensor unit.

FIG. 3 shows procedures of an action carried out by a user in the embodiment.

FIG. 4 shows an example of a screen displayed on a display unit of a computing device.

FIG. 5 shows an example of the configuration of a motion measurement system according to a first embodiment.

FIG. 6 shows an example of a time chart of actions by the user, processing by the sensor unit, and processing by the computing device in the first embodiment.

FIG. 7 is a flowchart showing an example of procedures of motion measurement processing by the computing device in the first embodiment.

FIG. 8 is a flowchart showing an example of procedures of measurement processing by the sensor unit in the first embodiment.

FIG. 9 shows an example of the configuration of a motion measurement system according to a second embodiment.

FIG. 10 shows an example of a time chart of actions by the user, processing by the sensor unit and processing by the computing device in the second embodiment.

FIG. 11 is a flowchart showing an example of procedures of motion measurement processing by the computing device in the second embodiment.

FIG. 12 is a flowchart showing an example of procedures of measurement processing by the sensor unit in the second embodiment.

FIG. 13 shows an example of the configuration of a motion measurement system according to a third embodiment.

FIG. 14 shows an example of a time chart of actions by the user, processing by the senior unit and processing by the computing device in the third embodiment.

FIG. 15 is a flowchart showing an example of procedures of motion measurement processing by the computing device in the third embodiment.

FIG. 16 is a flowchart showing an example of procedures of measurement processing by the sensor unit in the third embodiment.

### DESCRIPTION OF EXEMPLARY EMBODIMENTS

Hereinafter, preferred embodiments of the invention will be described in detail with reference to the drawings. The embodiments described below are not to unduly limit the contents of the invention described in the appended claims. Not all of the configurations described below are necessarily essential components of the invention.

In the description below, a motion measurement system which analyzes golf swings (swing measurement system) is employed as an example.

### 1. Motion Measurement System

### 1-1. First Embodiment

### 1-1-1. Outline of Motion Measurement System

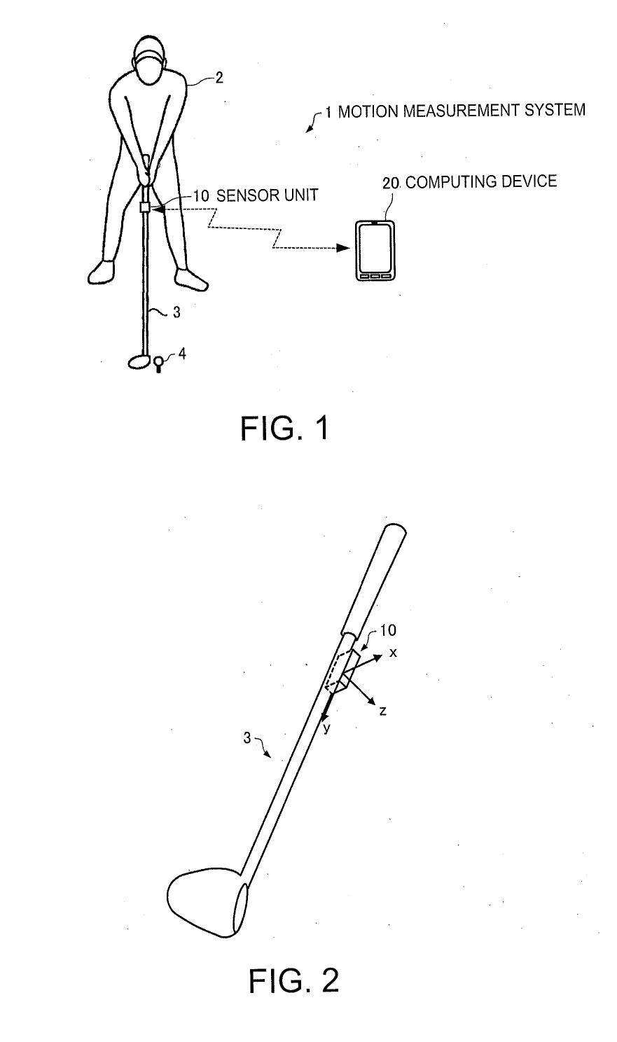

FIG. 1 is a view for explaining an outline of the motion measurement system in this embodiment. The motion measurement system. 1 in this embodiment includes a sensor unit (an example of a sensor) and a computing device 20.

The sensor unit 10 is capable of measuring an acceleration generated in each of the directions of three axes and an angular velocity generated around each of the three axes, and is installed on a golf club 3.

In the embodiment, as shown in FIG. 2, the sensor unit 10 is attached to a part of the shaft of the golf club 3, with one of three detection axes (x-axis, y-axis, z-axis), for example, the y-axis, aligned with the direction of the longitudinal axis of the shaft. Preferably, the sensor unit 10 is attached at a position close to the grip, to which the impact of ball hitting is hard to propagate and to which the centrifugal force at the time of a swing is not applied. The shaft is a rod part of the golf club 3 excluding the head and including the grip. However, the sensor unit 10 may be attached to a part (for example, a hand, glove or the like) of a user 2 (an example of a measurement target) or may be attached to accessories such as a wristwatch.

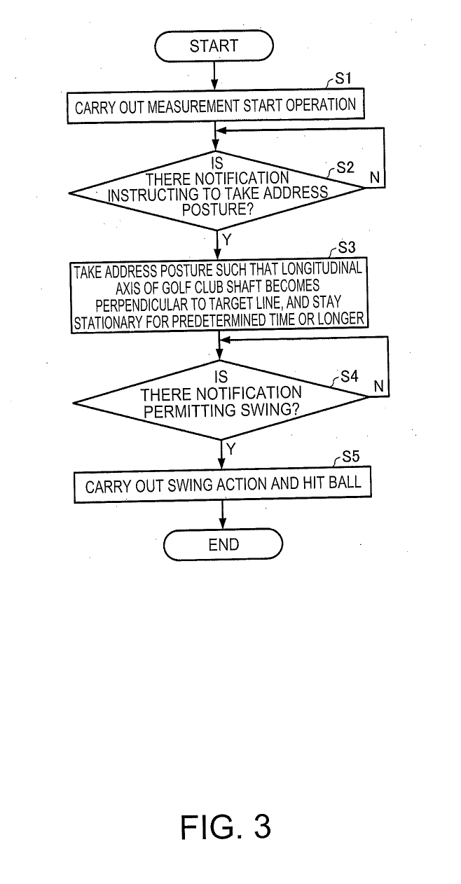

The user 2 carries out a swing action of hitting a golf ball 4 according to predetermined procedures. FIG. 3 shows the procedures of the action carried out by the user 2. As shown in FIG. 3, first, the user 2 carries out a measurement start operation via the computing device 20 (operation to cause the sensor unit 10 to start measurement) (S1). Next, the user 2 receives a notification instructing the user 2 to take an address posture (for example, an audio notification) from the computing device 20 (Y in S2). Subsequently, the user 2 takes an address posture such that the longitudinal axis of the shaft of the golf club 3 becomes perpendicular to a target line (target direction in which the ball should be hit), and the user 2 then becomes stationary (S3). Next, the user 2 receives a notification permitting a swing (for example, an audio notification) from the computing device 20 (Y in S4). Subsequently, the user 2 carries out a swing action and hits the golf ball 4 (S5).

As the user 2 carries out the measurement start operation of S1 in FIG. 3, the sensor unit 10 measures accelerations on the three axes and angular velocities around the three axes and sequentially transmits the measured data to the computing device 20. The communication between the sensor unit 10 and the computing device 20 may be wireless communication or wired communication.

The computing device 20 analyzes the swing motion in which the user 2 hits the ball with the golf club 3, using the data measured by the sensor unit 10. For example, the computing device 20 may generate trajectory information of the head or grip end of the golf club 3 in the swing, using the measured data measured by the sensor unit 10, and then display the trajectory information on a display unit (display). The computing device 20 may be, for example, a mobile device such as a smartphone, or a personal computer (PC).

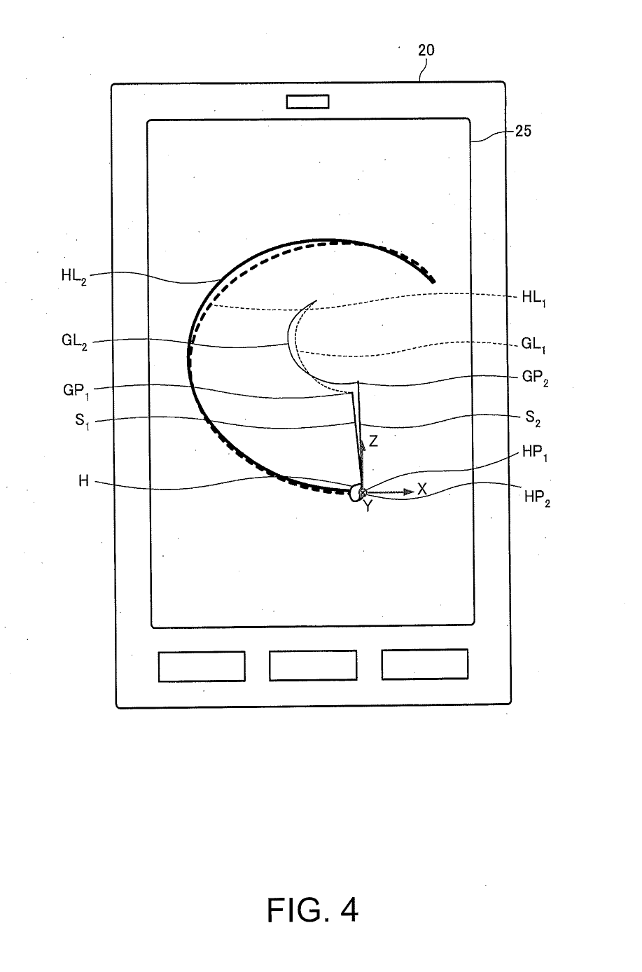

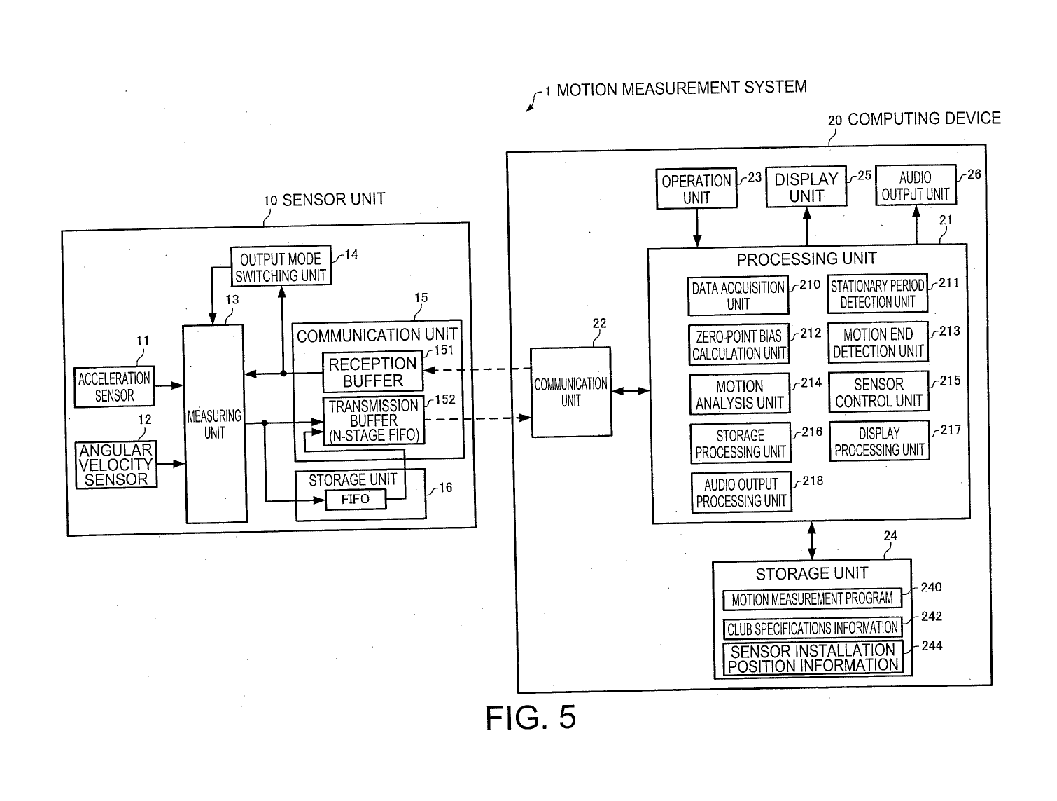

FIG. 4 shows an example of a screen displayed on a display unit 25 (see FIG. 5) of the computing device 20. In the embodiment, an XYZ coordinate system (global coordinate system) is defined where the target line indicating the target direction in which the ball should be hit is the X-axis, the axis on a horizontal plane perpendicular to the X-axis is the Y-axis, and the vertical direction (opposite to the direction of gravitational acceleration) is the Z-axis. On the screen shown in FIG. 4, information on the X-axis, Y-axis and Z-axis is included. Also, on the screen shown in FIG. 4, S₁, HP₁, and GP₁ indicate the shaft, the position of the head, and the position of the grip at the start of the swing, respectively, and S₂, HP₂, and GP₂ indicate the shaft, the position of the head, and the position of the grip at the time of impact, respectively. The position of the head HP₁ at the start of the swing corresponds to the origin (0, 0, 0) of the XYZ coordinate system. A dashed line HL₁ and a solid line HL₂ show the trajectory of the head in the backswing and the trajectory of the head in the downswing, respectively. A dashed line GL₁ and a solid line GL₂ show the trajectory of the grip in the backswing and the trajectory of the grip in the downswing, respectively. The connecting point between the dashed line HL₁ and the solid line HL₂ and the connecting point between the dashed line GL₁ and the solid line GHL₂ correspond to the position of the head and the position of the grip when the swing is at the top (when the direction of the swing is switched), respectively.

In the embodiment, the sensor unit 10 has two output modes, that is, a real-time mode (an example of the first mode) and a buffering mode (an example of the second mode). In the real-time mode, the sensor unit 10 restrains output delay and gives priority to real-time output (transmission), even by destroying a part of the measured data. In the buffering mode, the sensor unit 10 outputs (transmits) all of the measured data even by delaying the output.

In response to the measurement start operation by the user 2 in S1 of FIG. 3, the sensor unit 10 starts measurement at a predetermined sampling rate (for example, 1 kHz). Then, during the stationary period when the user is stationary in S3 of FIG. 3 (an example of the stationary period of the measurement target), the sensor unit 10 outputs and transmits measured data (an example of the first measured data) in real-time mode to the computing device 20 (an example of the first measured data output process).

The computing device 20 receives the measured data and detects a predetermined stationary period (for example, a stationary period of one second) of the user 2 on the basis of the measured data (an example of the stationary period detection process). If the stationary period of the user 2 is detected, the computing device 20 transmits a buffering mode setting command instructing the sensor unit 10 to switch to the buffering mode (an example of the first switch signal), to the sensor unit 10 (an example of the first switch signal transmission process).

The sensor unit 10 receives the buffering mode setting command and switches the output mode to the buffering mode on the basis of the command (an example of the first output mode switching process). Then, in the period of the swing action by the user 2 in S5 of FIG. 3 (an example of the motion period of the measurement target), the sensor unit 10 outputs and transmits measured data (an example of the second measured data) in the buffering mode to the computing device 20 (an example of the second measured data output process).

The computing device 20 receives the measured data and analyzes the swing motion by the user 2, using the measured data (an example of the motion analysis process).

Moreover, the computing device 20 receives the measured data and detects an end of the swing motion by the user 2 (an example of the motion end detection process). If the end of the swing motion by the user 2 is detected, the computing device 20 transmits a real-time mode setting command instructing the sensor unit 10 to switch to the real-time mode (an example of the second switch signal), to the sensor unit (an example of the second switch signal transmission process).

The sensor unit 10 receives the real-time mode setting command and switches the output mode to the real-time mode on the basis of the command (an example of the second output mode switching process).

### 1-1-2. Configuration of Motion Measurement System

FIG. 5 shows an example of the configuration of the motion measurement system 1 (an example of the configuration of the sensor unit 10 and the computing device 20) according to the first embodiment. As shown in FIG. 5, in this embodiment, the sensor unit 10 includes an acceleration sensor 11, an angular velocity sensor 12, a measuring unit 13, an output mode switching unit 14, a communication unit 15, and a storage unit 16.

The acceleration sensor 11 measures an acceleration generated in each of the directions of three axes intersecting with each other (ideally, orthogonal to each other), and outputs a digital signal (acceleration data) corresponding to the magnitude and direction of the measured accelerations on the three axes.

The angular velocity sensor 12 measures an angular velocity generated around each of the directions of three axes intersecting with each other (ideally, orthogonal to each other), and outputs a digital signal (angular velocity data) corresponding to the magnitude and direction of the measured angular velocities on the three axes.

If the measuring unit 13 receives a measurement start command from the communication unit 15, the measuring unit 13 acquires the acceleration data and the angular velocity data from the acceleration sensor 11 and the angular velocity sensor 12, respectively, then adds time information to the acceleration data and the angular velocity data thus acquired, to generate measured data corresponding to the communication format used, and outputs the measured data to the communication unit 15. Meanwhile, if the measuring unit 13 receives a measurement end command from the communication unit 15, the measuring unit 13 ends (stops) the acquisition of the acceleration data and the angular velocity data, the generation of the measured data, and the output of the measured data to the communication unit 15.

Ideally, the acceleration sensor 11 and the angular velocity sensor 12 should be attached to the sensor unit 10 in such a way that the three axes coincide with the three axes (x-axis, y-axis, z-axis) of the orthogonal coordinate system (sensor coordinate system) defined for the sensor unit 10. However, in practice, an error occurs in the angle of attachment. Thus, the measuring unit 13 may carry out processing of converting the acceleration data and the angular velocity data into data in the xyz coordinate system, with the use of a correction parameter calculated in advance according to the error in the angle of attachment.

The measuring unit 13 may also carry out temperature correction processing for the acceleration sensor 11 and the angular velocity sensor 12. Alternatively, the function of temperature correction may be incorporated in the acceleration sensor 11 and the angular velocity sensor 12.

The acceleration sensor 11 and the angular velocity sensor 12 may output analog signals. In this case, the measuring unit 13 may perform A/D conversion of the output signal from the acceleration sensor 11 and the output signal from the angular velocity sensor 12 and thus generate measured data.

The communication unit 15 carries out processing of receiving the measured data outputted from the measuring unit 13 and transmitting the measured data to the computing device 20, and processing of receiving various control commands from the computing device 20 (measurement start command, measurement end command, real-time mode setting command, buffering mode setting command and the like) and sending the commands to the measuring unit 13 or the output mode switching unit 14, and the like. In this embodiment, the communication unit 15 includes a reception buffer 151 and a transmission buffer 152.

The communication unit 15 receives a control command transmitted from the computing device 20, by writing the control command in the reception buffer. The transmission buffer 152 is configured as an N-stage (N being a positive integer) FIFO (first-in first-out) and can hold up to N pieces of measured data when outputting the measured data measured by the measuring unit 13 to outside. When transmission to the computing device 20 is possible, the communication unit 15 transmits the leading measured data in the transmission buffer 152 (N-stage FIFO) to the computing device 20.

The output mode switching unit 14 switches the output mode for outputting the measured data measured by the measuring unit 13 to outside. In this embodiment, the output mode of the sensor unit 10 includes the real-time mode (an example of the first mode) and the buffering mode (an example of the second mode). The real-time mode is a mode in which the transmission buffer 152 (N-stage FIFO) is overwritten with the measured data measured by the measuring unit 13 if there is no free space in the transmission buffer 152 (N-stage FIFO) (an example of the first buffer). The buffering mode is a mode in which the measured data measured by the measuring unit 13 is written in a FIFO (an example of the second buffer) formed in the storage unit 16 if there is no free space in the transmission buffer 152 (N-stage FIFO) and in which the measured data written in the FIFO formed in the storage unit 16 is transferred to the transmission buffer 152 (N-stage FIFO) if a free space is generated in the transmission buffer 152 (N-stage FIFO).

In the real-time mode, when the transmission buffer 152 (N-stage FIFO) is not full (when fewer than N pieces of measured data are held therein), the measuring unit 13 writes new measured data in the transmission buffer 152 (N-stage FIFO), whereas when the transmission buffer 152 (N-stage FIFO) is full (N pieces of measured data are held therein), the measuring unit 13 creates a free space by shifting the transmission buffer 152 (N-stage FIFO) by one stage and thus destroying the leading data, and then writes new measured data in the transmission buffer 152 (N-stage FIFO) (overwrites the transmission buffer 152 (N-stage FIFO) with new measured data). Meanwhile, in the buffering mode, when the transmission buffer 152 (N-stage FIFO) is not full, the measuring unit 13 writes new measured data in the transmission buffer 152 (N-stage FIFO), whereas when the transmission buffer 152 (N-stage FIFO) is full, the measuring unit 13 writes new measured data in the FIFO formed in the storage unit 16.

In the case where a free space is generated in the transmission buffer 152 (N-stage FIFO), if measured data is written in the FIFO formed in the storage unit 16, the communication unit 15 takes out the measured data written at the leading part of the FIFO formed in the storage unit 16 and writes this measured data at the end of the transmission buffer 152 (N-stage FIFO).

The storage unit 16 is a large-capacity memory. The FIFO formed in the storage unit 16 is set in a sufficient size to store all the necessary measured data for the processing by the computing device 20, in consideration of the time required for a series of actions (address, waggle, swing and the like) related to a swing motion by the user 2, and the communication environment (communication rate) between the sensor unit 10 and the computing device 20, and the like.

In this embodiment, if the measuring unit 13 receives a measurement start command from the communication unit 15, the measuring unit 13 starts measurement at a predetermined sampling rate (for example, 1 kHz) and outputs the measured data in the real-time mode. If the output mode switching unit receives a buffering mode setting command from the communication unit 15, the output mode switching unit 14 switches the output mode to the buffering mode. Meanwhile, if the output mode switching unit 14 receives a real-time mode setting command from the communication unit 15 when the output mode is the buffering mode, the output mode switching unit 14 switches the output mode to the real-time mode.

In the sensor unit 10 with the configuration as described above, in the real-time mode, even if there is no free space in the transmission buffer 152 (N-stage FIFO), measured data can continue being transmitted almost in real time to the computing device 20 while the oldest measured data held in the transmission buffer 152 (N-stage FIFO) is destroyed (the latest measured data is left in the buffer). Meanwhile, in the sensor unit 10 in the buffering mode, if there is no free space in the transmission buffer 152 (N-stage FIFO), measured data is accumulated in the FIFO formed in the storage unit 16 and therefore all the necessary measured data can be transmitted to the computing device 20 even if the delay increases.

The computing device 20 includes a processing unit 21, a communication unit 22, an operation unit 23, a storage unit 24, a display unit 25, and an audio output unit 26.

The communication unit 22 carries out processing of receiving measured data transmitted from the sensor unit 10 and sending the measured data to the processing unit 21, and processing of receiving a control command from the processing unit 21 and transmitting the control command to the sensor unit 10, and the like.

The operation unit 23 carries out processing of acquiring operation data from the user 2 and sending the operation data to the communication unit 22. The operation unit 23 may be, for example, a touch panel display, buttons, keys, and a microphone, or the like.

The storage unit 24 is made up of, for example, various IC memories such as a ROM (read only memory), flash ROM or RAM (random access memory), or a recording medium such as a hard disk or memory card.

The storage unit 24 stores programs for the processing unit 21 to carry out various calculation processing and control processing, and various programs and data or the like for realizing application functions. Particularly in this embodiment, a motion measurement program 240 which is read by the processing unit 21 so as to execute processing of measuring a swing motion by the user 2 is stored in the storage unit 24. The motion measurement program 240 may be stored in a non-volatile recording medium in advance, or may be received by the processing unit 21 from the server via a network and stored in the storage unit 24.

Also, club specifications information 242 describing the specifications of the golf club 3, and sensor installation position information 244 may be stored in the storage unit 24. For example, the user 2 may input the model number of the golf club 3 to be used (or choose from a model number list), by operating the operation unit 23, and the specifications information corresponding to the inputted model number may be used as club specifications information 242, from among the specifications information (for example, information such as the length of the shaft, the position of the center of gravity, the lie angle, the face angle, and the loft angle) corresponding to each model number stored in the storage unit 24 in advance. Also, for example, the user 2 may input the distance between the installation position of the sensor unit 10 and the grip of the golf club 3, by operating the operation unit 23, and the information of the inputted distance may be stored as the sensor installation position information 244 in the storage unit 24. Alternatively, on the assumption that the sensor unit 10 is installed at a predetermined position (for example, at 20 cm from the grip end, or the like), the information of the predetermined position may be stored in advance as the sensor installation position information 244.

The storage unit 24 is also used as a work area for the processing unit 21 and temporarily stores data inputted from the operation unit 23, the result of computations executed by the processing unit 21 according to various programs, and the like. Moreover, the storage unit 24 may store data that need to be saved for a long period, from among data generated through the processing by the processing unit 21.

The display unit 25 is to display the result of the processing by the processing unit 21 in the form of letters, graphs, tables, animations or other images. The display unit 25 may be, for example, a CRT, LCD, touch panel display, HMD (head-mounted display), or the like. Also, the functions of the operation unit 23 and the display unit 25 may be realized by a single touch panel display.

The audio output unit 26 is to output the result of the processing by the processing unit 21 in the form of voices or various other sounds. The audio output unit 26 may be, for example, a speaker, buzzer, or the like.

The processing unit 21 carries out processing of transmitting a control command to the sensor unit 10, various kinds of calculation processing on the measured data received from the sensor unit 10 via the communication unit 22, and various other kinds of control processing, according to various programs. Particularly in this embodiment, the processing unit 21 functions as a data acquisition unit 210, a stationary period detection unit 211, a zero-point bias calculation unit 212, a motion end detection unit 213, a motion analysis unit 214, a sensor control unit 215, a storage processing unit 216, a display processing unit 217 and an audio output processing unit 218, by executing the motion measurement program 240.

The data acquisition unit 210 carries out processing of acquiring the measured data received by the communication unit 22 from the sensor unit 10 and sending the measured data to the storage processing unit 216.

The storage processing unit 216 carries out processing of receiving the measured data from the data acquisition unit 210 and causing the measured data to be stored in the storage unit 24.

The stationary period detection unit 211 carries out processing of detecting the stationary period during which the user 2 is stationary in S3 of FIG. 3, on the basis of the measured data outputted from the sensor unit 10 in the real-time mode. The stationary period detection unit 211 may detect the stationary period if the measured data (three-axis acceleration data and three-axis angular velocity data) are within a predetermined range for a predetermined time (for example, one second).

The zero-point bias calculation unit 212 carries out processing of calculating a zero-point bias value of the measured data from the sensor unit 10 if the stationary period detection unit 211 detects the stationary period. The zero-point bias calculation unit 212 may calculate an average value of the measured data in the stationary period (average value of each of the three-axis acceleration data and average value of each of the three-axis angular velocity data) and use these average values as zero-point bias values.

The motion end detection unit 213 carries out processing of detecting the end of the swing motion (action in S5 of FIG. 3) by the user 2 on the basis of the measured data outputted from the sensor unit 10 in the buffering mode. For example, the motion end detection unit 213 may detect the state where the user 2 becomes stationary after the impact (stationary state after the follow-through), as the end of the swing motion.

The motion analysis unit 214 carries out processing of analyzing the swing motion (action in S5 of FIG. 3) by the user 2, using the measured data outputted from the sensor unit 10 in the buffering mode.

In this embodiment, the motion analysis unit 214 carries out processing of detecting the timing of each action in the swing motion by the user 2 (measured time of the measured data), using the measured data outputted in the buffering mode. Specifically, first, the motion analysis unit 214 detects the timing of the impact, using the measured data. Next, the motion analysis unit 214 detects the timing when the direction of the swing changes (timing of the top when the backswing changes to the downswing), using the measured data before the timing of the impact. Next, the motion analysis unit 214 detects the timing of the start of the swing, using the measured data before the timing when the direction of the swing changes. For example, the motion analysis unit 214 may calculate a combined value of the measured data (acceleration data or angular velocity data) and detect each of the timings of the impact, the top, and the start of the swing, using the combined value. Here, as the combined value of angular velocities, the square root of the sum of squares of the angular velocities around the respective axes, the sum of squares of the angular velocities around the respective axes, the sum of the angular velocities around the respective axes or the average value thereof, the product of the angular velocities around the respective axes, or the like may be used. Similarly, as the combined value of accelerations, the square root of the sum of squares of the accelerations on the respective axes, the sum of squares of the accelerations on the respective axes, the sum of the accelerations on the respective axes or the average value thereof, the product of the accelerations on the respective axes, or the like may be used.

The motion analysis unit 214 also calculates the position and attitude (attitude angle) (position and attitude in the XYZ coordinate system (global coordinate system)) of the sensor unit 10 in the swing motion by the user 2, using the measured data outputted in the buffering mode.

Specifically, the motion analysis unit 214 performs bias correction on the measured data (three-axis acceleration data and three-axis angular velocity data) corresponding to the swing action (action in S5 of FIG. 3) by the user 2, using the zero-point bias values calculated by the zero-point bias calculation unit 212, and calculates the position and attitude (attitude angle) of the sensor unit 10 during the swing action by the user 2, using the bias-corrected measured data.

For example, the motion analysis unit 214 calculates the position (initial position) of the sensor unit 10 when the user 2 is stationary (at the address) in the XYZ coordinate system (global coordinate system), using the three-axis acceleration data, the club specifications information 242 and the sensor installation position information 244, and integrates the subsequent acceleration data to calculate, in time series, the change in the position from the initial position of the sensor unit 10.

Since the user 2 carries out the action of S3 in FIG. 3, the X-coordinate of the initial position of the sensor unit 10 is 0. Also, as shown in FIG. 2, the y-axis of the sensor unit 10 coincides with the direction of the longitudinal axis of the shaft of the golf club 3, and when the user 2 is stationary, the acceleration sensor 11 only measures the gravitational acceleration. Therefore, the motion analysis unit 214 can calculate the angle of inclination of the shaft (inclination with respect to the horizontal plane (XY plane) or the vertical plane (XZ plane)), using the y-axis acceleration data. The motion analysis unit 214 then finds the distance L_{SH} between the sensor unit 10 and the head on the basis of the club specifications information 242 (length of the shaft) and the sensor installation position information 244 (distance from the grip), and defines, as the initial position of the sensor unit 10, the position apart from the origin (0, 0, 0), which is the position of the head, for example, by the distance L_{SH} in the negative direction on the y-axis of the sensor unit 10 specified by the angle of inclination of the shaft.

The motion analysis unit 214 also calculates the attitude (initial attitude) of the sensor unit 10 when the user 2 is stationary (at the address) in the XYZ coordinate system (global coordinate system), using the acceleration data measured by the acceleration sensor 11, and integrates the subsequent angular velocity data (rotation computation) to calculate, in time series, the change in the attitude from the initial attitude of the sensor unit 10. The attitude of the sensor unit 10 can be expressed by the rotation angles (roll angle, pitch angle, and yaw angle) around the X-axis, Y-axis, and Z-axis, or quaternions (four-dimensional numbers) or the like. When the user 2 is stationary, the acceleration sensor 11 only measures the gravitational acceleration. Therefore, the motion analysis unit 214 can specify the angles formed by each of the x-axis, y-axis and z-axis of the sensor unit 10, and the direction of gravity, using the three-axis acceleration data. Moreover, since the user 2 carries out the action of Step S3 in FIG. 3, the y-axis of the sensor unit 10 is on the YZ plane when the user 2 is stationary. Therefore, the motion analysis unit 214 can specify the initial attitude of the sensor unit 10.

The motion analysis unit 214 also carries out processing of analyzing the swing motion by the user 2 with the use of each detected action and the position and attitude of the sensor unit 10 that are calculated, and generating analysis information, which is the result of the analysis.

For example, the motion analysis unit 214 may calculate, in time series, the positions of the head and the grip end of the golf club 3 in the swing motion by the user 2 and generate information of the trajectory of the golf club 3 (trajectories of the head and the grip end) on the basis of the result of the calculation. The motion analysis unit 214 may define the position apart from the position of the sensor unit 10 at each time during the swing by the distance L_{SH} in the positive direction on the y-axis of the sensor unit 10 specified by the attitude of the sensor unit 10 at that time, as the position of the head at that time. Also, the motion analysis unit 214 may define the position apart from the position of the sensor unit 10 at each time during the swing by the distance L_{SG} between the sensor unit 10 and the grip end specified by the sensor installation position information 244 (distance from the grip end) in the negative direction on the y-axis of the sensor unit 10 specified by the attitude of the sensor unit 10 at that time, as the position of the grip end at that time. Then, using the time-series information of the positions of the head and the grip end of the golf club 3, the motion analysis unit 214 may, for example, connect the positions (coordinates) of the head from the start of the swing to the impact in order in a line and similarly connect the positions (coordinates) of the grip end from the start of the swing to the impact in order in a line, thus generating trajectory information (trajectory information as shown in FIG. 4) including the trajectory of the head and the trajectory of the grip end from the start of the swing to the impact.

The motion analysis unit 214 may also generate, for example, swing tempo information including information of a part or all of the time of the backswing, the time of the top section, the time of the downswing, and the time of the follow-through or the like, on the basis of the timing of each action during the swing motion by the user 2. The motion analysis unit 214 may also calculate the proportion of the time of the backswing and the time of the downswing and the proportion of the time of the top section (time of maintenance of the top) and the time of the downswing, and generate swing rhythm information including information of these proportions.

Moreover, the motion analysis unit 214 may also generate information such as the head speed and the grip speed at the impact, the angle of incidence (club path) and the face angle of the head at the impact, the shaft rotation (amount of change in the face angle during the swing), and the slowdown rate of the head, using the information of the positions and attitudes of the head and the grip end, or may generate information of variation in each of these kinds of information in the case where the user 2 carries out multiple swings.

The sensor control unit 215 carries out processing of generating various control commands to the sensor unit 10 and sending the control commands to the communication unit 22. Specifically, if operation data corresponding to the measurement start operation (S1 in FIG. 4) by the user 2 is received from the operation unit 23, the sensor control unit 215 generates a measurement start command and sends this command to the communication unit 22. If operation data corresponding to the measurement end operation by the user 2 is received from the operation unit 23, the sensor control unit 215 generates a measurement end command and sends this command to the communication unit 22. If the stationary period detection unit 211 detects the stationary period, the sensor control unit 215 generates a buffering mode setting command and sends this command to the communication unit 22. If the motion end detection unit 213 detects the end of the swing motion by the user 2, the sensor control unit 215 generates a real-time mode setting command and sends this command to the communication unit 22.

The storage processing unit 216 carries out processing of reading and writing various programs and various data from and into the storage unit 24. The storage processing unit 216 also carries out processing of causing the measured data received from the data acquisition unit 210 to be stored in the storage unit 24 and processing of causing various kinds of information and the like calculated by the motion analysis unit 214 to be stored in the storage unit 24.

The display processing unit 217 carries out processing of causing the display unit 25 to display various images (image corresponding to the analysis information generated by the motion analysis unit 214, and the like). For example, the display processing unit 217 may cause the display unit 25 to display an image corresponding to the analysis information automatically or in response to an input operation by the user 2, after the swing motion by the user 2 is finished. Also, a display unit may be provided in the sensor unit 10, and the display processing unit 217 may transmit image data to the sensor unit 10 via the communication unit 22 and thus cause various images, letters and the like to be displayed on the display unit of the sensor unit 10.

The audio output processing unit 218 carries out processing of causing the audio output unit 26 to output voices and various other sounds. For example, if the user 2 carries out a measurement start operation, the audio output processing unit 218 may cause the audio output unit 26 to output a voice instructing the user 2 to take an address posture (for example, “stay still in the address posture for one second or longer”). If the motion end detection unit 213 detects the end of the swing motion by the user 2, the audio output processing unit 218 may similarly cause the audio output unit 26 to output a voice instructing the user 2 to take an address posture, after the lapse of a predetermined time. If the stationary period detection unit 211 detects the stationary period, the audio output processing unit 218 may cause the audio output unit 26 to output a voice permitting the user 2 to swing (for example, “please swing”). Moreover, the audio output processing unit 218 may cause a sound or voice corresponding to the analysis information to be outputted automatically or in response to an input operation by the user 2, after the swing motion by the user 2 is finished. Also, an audio output unit may be provided in the sensor unit 10, and the audio output processing unit 218 may transmit various sound data and voice data to the sensor unit 10 via the communication unit 22 and thus cause the audio output unit in the sensor unit 10 to output various sounds and voices.

Moreover, a light emitting unit and an oscillation mechanism may be provided in the computing device 20 or the sensor unit 10, and the light emitting unit or the oscillation mechanism may convert various kinds of information into optical information or oscillatory information to notify the user 2.

### 1-1-3. Processing in Motion Measurement System Time Chart

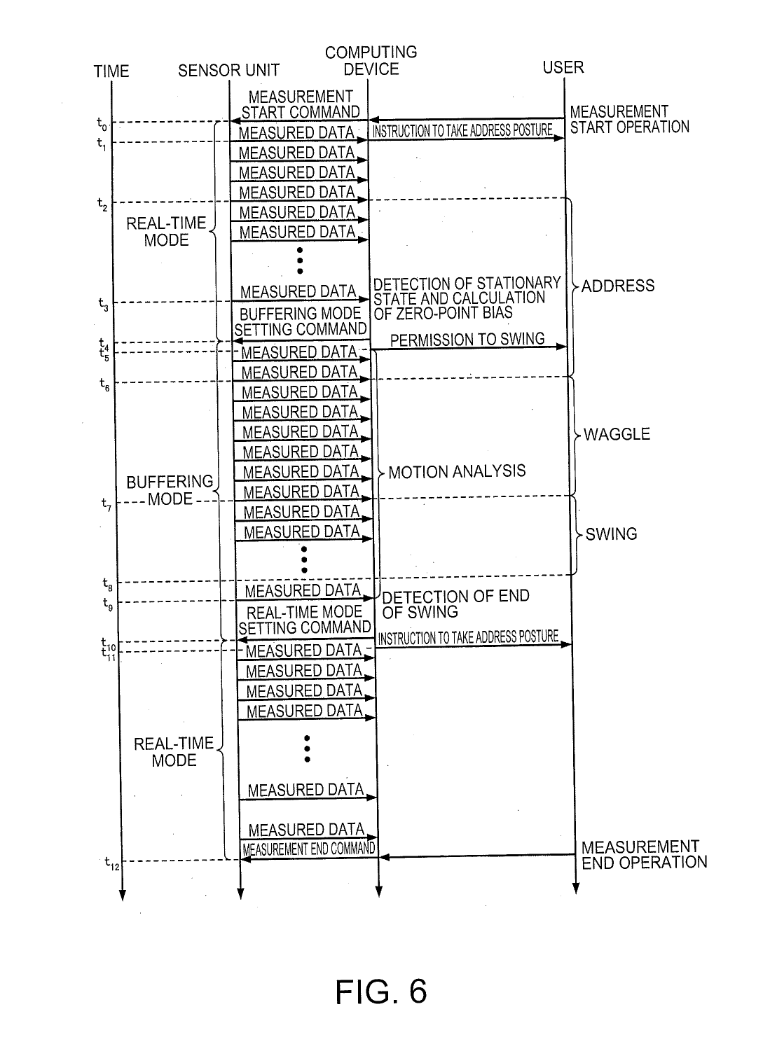

FIG. 6 shows an example of a time chart of actions by the user 2, processing by the sensor unit 10 and processing by the computing device 20 in the first embodiment. In the example of FIG. 6, at a time t₀, the computing device 20 transmits a measurement start command to the sensor unit 10 in response to a measurement start operation carried out by the user 2. The sensor unit 10 receives the measurement start command, then starts measurement at a predetermined sampling rate, and transmits measured data successively to the computing device 20, in the real-time mode.

At a time t₁, the computing device 20 gives the user 2 a notification instructing the user 2 to take an address posture. The user 2, receiving this notification, becomes stationary in the address posture from a time t₂ onward.

At a time t₃, the computing device 20 detects a predetermined stationary period and performs zero-point bias calculation using the measured data measured during the stationary period.

At a time t₄, the computing device 20 transmits a buffering mode setting command to the sensor unit 10. The sensor unit 10 receives the buffering mode setting command, then switches the output mode to the buffering mode, and transmits measured data successively to the computing device 20, in the buffering mode.

At a time t₅, the computing device 20 gives the user 2 a notification permitting the user 2 to swing. The user 2, receiving this notification, performs a waggle from a time t₆ onward and then performs a swing action (backswing, downswing, and follow-through) during the period from a time t₇ to a time t₈.

The computing device 20 analyzes the swing motion, using the measured data, and detects the end of the swing action at a time t₉.

At a time t₁₀, the computing device 20 transmits a real-time mode setting command to the sensor unit 10. The sensor unit 10 receives the real-time mode setting command, then switches the output mode to the real-time mode, and transmits measured data successively to the computing device 20, in the real-time mode.

At a time t₁₁, the computing device 20 gives the user 2 a notification instructing the user 2 to take an address posture.

At the time t₁₁ and onward, the user 2 may repeat the series of actions (address, waggle, and swing) similar to that carried out at the times t₂ to t₈. The sensor unit 10 and the computing device 20 repeat the processing similar to that carried out at the times t₂ to t₁₁, according to each action of the series of actions by the user 2.

Subsequently, at a time t₁₂, in response to a measurement end operation carried out by the user 2, the computing device 20 transmits a measurement end command to the sensor unit 10 and ends the processing. The sensor unit 10 receives the measurement end command and ends the measurement.

In order to minimize the time during which the user 2 is stationary in the address posture (times t₂ to t₆ in FIG. 6) and thus enhance convenience, the computing device 20 needs to detect the stationary period in real time as much as possible. Thus, in the embodiment, during the period when the user 2 is stationary in the address posture, the output mode of the sensor unit 10 is set to the real-time mode. In the real-time mode, when the transmission buffer 152 (N-stage FIFO) is full, the sensor unit 10 constantly holds the state where N or fewer pieces of the latest measured data are written into the transmission buffer 152 (N-stage FIFO) while destroying the oldest measured data. Since the sensor unit 10 in the real-time mode transmits the latest measured data or measured data close to the latest to the computing device 20 when transmission is possible, the computing device 20 can detect the stationary period securely in real time. Also, the computing device 20 calculates the zero-point bias value using the measured data during the stationary period. Since there is only small variation in the measured data during the period when the user 2 is stationary, destruction of a part of the measured data has little influence. Therefore, the time during which the user 2 is stationary in the address posture (times t₂ to t₆ in FIG. 6) can be reduced securely and the convenience for the user 2 can be enhanced.

Meanwhile, during the swing action by the user 2 (times t₇ to t₈ in FIG. 6), the output mode of the sensor unit 10 is set to the buffering mode. In the buffering mode, when the transmission buffer 152 (N-stage FIFO) is full, the sensor unit 10 writes the latest measured data into the FIFO formed in the storage unit 16. Therefore, the measured data necessary for motion analysis can be transmitted entirely to the computing device 20.

In this way, in the embodiment, during the period when the user 2 is stationary, the computing device 20 can detect the stationary period in real time, and during the swing action by the user 2, the computing device 20 can acquire a large number of pieces of measured data and thus perform accurate motion analysis.

### Processing Procedures by Computing Device

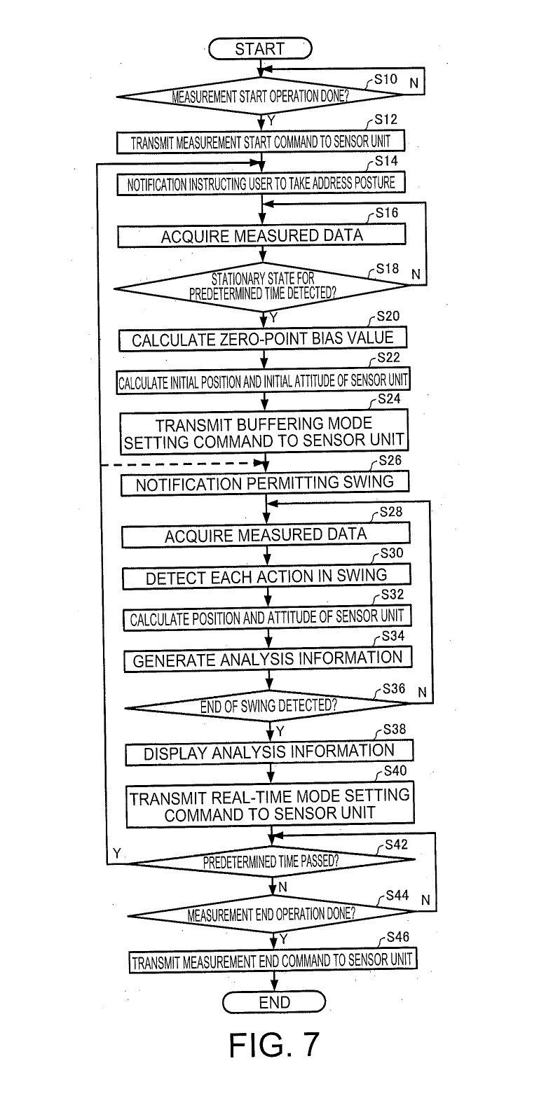

FIG. 7 is a flowchart showing procedures of motion measurement processing by the processing unit 21 of the computing device 20 in the first embodiment. The processing unit 21 of the computing device 20 (an example of a computer) executes the motion measurement program 240 stored in the storage unit 24 and thereby executes the motion measurement processing according to the procedures in the flowchart of FIG. 7. Hereinafter, the flowchart of FIG. 7 will be described.

First, the processing unit 21 waits until a measurement start operation is carried out by the user 2 (N in S10). If a measurement start operation is carried out (Y in S10), the processing unit 21 transmits a measurement start command to the sensor unit 10 via the communication unit 22 (S12).

The processing unit 21 also gives the user 2 a notification instructing the user 2 to take an address posture, in the form of a voice or the like (S14).

Next, the processing unit 21 acquires measured data measured by the sensor unit 10 at a predetermined sampling rate (S16).

Next, the processing unit 21 repeats the processing of acquiring new measured data (S16) until the state where the user 2 continues being stationary for a predetermined time is detected (N in S18). If the stationary state for a predetermined time (stationary period) is detected (Y in S18), the processing unit 21 calculates a zero-point bias value, using the measured data corresponding to the stationary period (S20).

The processing unit 21 also calculates the initial position and initial attitude of the sensor unit 10, using the measured data corresponding to the stationary period acquired in the process S16, and the club specifications information 242 and the sensor installation position information 244 (S22).

The processing unit 21 also transmits a buffering mode setting command to the sensor unit 10 via the communication unit 22 (S24).

Moreover, the processing unit 21 gives the user 2 a notification permitting the user 2 to swing, in the form of a voice or the like (S26). Alternatively, an LED may be provided in the sensor unit 10, and the processing unit 21 may perform control to switch on the LED, or the like, via the communication unit 22, and thus give a notification permitting a swing.

Next, the processing unit 21 acquires measured data measured by the sensor unit 10 at a predetermined sampling rate (S28).

Next, the processing unit 21 detects each action in the swing, using the measured data acquired in the process S28 (S30).

The processing unit 21 also calculates the position and attitude of the sensor unit 10, using the measured data acquired in the process S28 (S32).

Next, the processing unit 21 analyzes the swing motion by the user 2, using the result of the detection of each action in the process S30 and the position and attitude of the sensor unit 10 calculated in the process S32 or the like, and thus generates analysis information, which is the result of the analysis (S34). In the process S34, the processing unit 21 generates, for example, analysis information of the rhythm and tempo of the swing, analysis information of the trajectories of the head and the grip end of the golf club 3 and the head speed and the grip speed at the impact, and the like.

Next, the processing unit 21 repeats the processing of the processes S28 to S34 until the state where the user 2 has ended the swing action (stationary state after the impact) is detected (N in S36). If the end of the swing action is detected (Y in S36), the processing unit 21 causes the display unit 25 to display the analysis information generated in the process S34 (S38).

The processing unit 21 also transmits a real-time mode setting command to the sensor unit 10 via the communication unit 22 (S40).

Then, if a measurement end operation is not carried out by the user 2 before a predetermined time passes (Y in S42), the processing unit 21 carries out the processing of the processes S14 to S40 again (or may carry out the processing of the processes S26 to S40).

Meanwhile, if a measurement end operation is carried out by the user 2 before a predetermined time passes (N in S42 and Y in S44), the processing unit 21 transmits a measurement end command to the sensor unit 10 via the communication unit (S46) and ends the processing.

In the flowchart of FIG. 7, the order of the processes may be changed suitably within a possible range.

### Processing Procedures by Sensor Unit

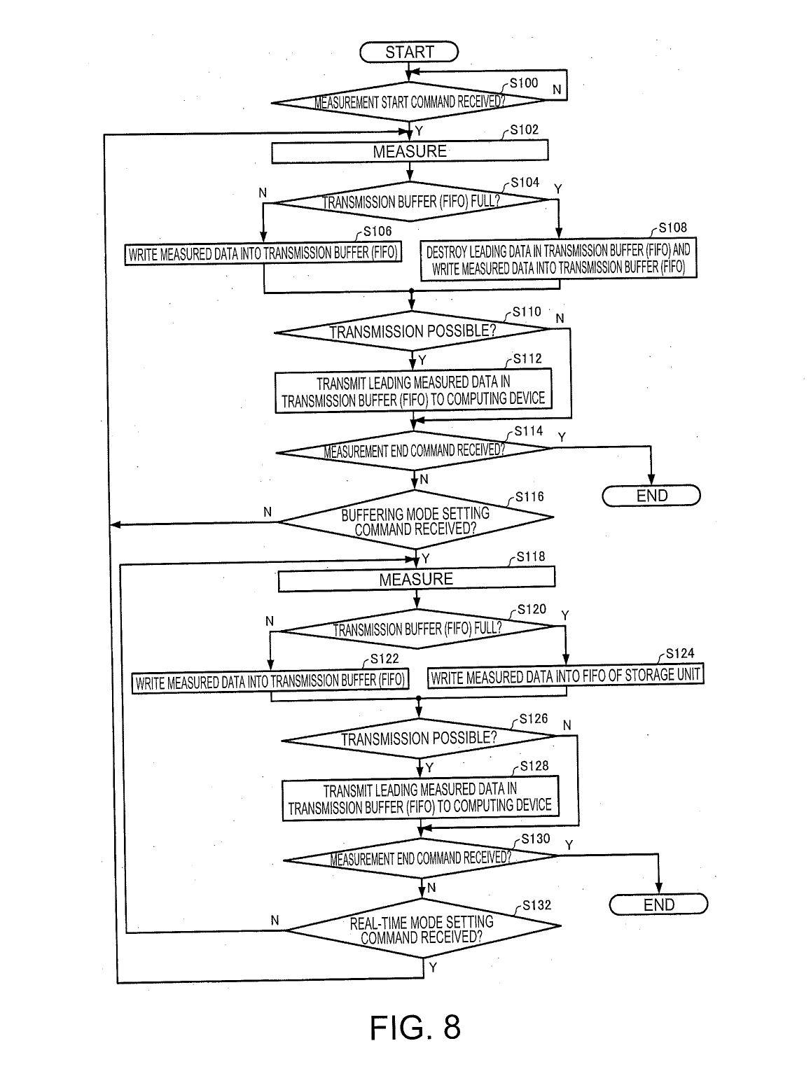

FIG. 8 is a flowchart showing procedures of measurement processing by the sensor unit 10 in the first embodiment. Hereinafter, the flowchart of FIG. 8 will be described.

First, the sensor unit 10 waits until a measurement start command is received from the computing device 20 (N in S100). If a measurement start command is received (Y in S100), the sensor unit 10 carries out measurement (acquires three-axis acceleration data and three-axis angular velocity data) at a predetermined sampling rate (S102).

Next, if the transmission buffer 152 (N-stage FIFO) is not full (N in S104), the sensor unit 10 writes the measured data acquired through the measurement in the process S102 into the transmission buffer 152 (N-stage FIFO) (S106). If the transmission buffer 152 (N-stage FIFO) is full (Y in S104), the sensor unit 10 destroys the leading data in the transmission buffer 152 (N-stage FIFO) and writes the measured data acquired through the measurement in the process S102 into the transmission buffer 152 (N-stage FIFO) (S108).

Next, if transmission is possible (Y in S110), the sensor unit 10 transmits the leading measured data in the transmission buffer 152 (N-stage FIFO) to the computing device (S112).

The sensor unit 10 repeats the processing of the processes S102 to S112 until a measurement end command or a buffering mode setting command is received from the computing device 20 (N in S114 and N in S116).

Then, if a measurement end command is received (Y in S114), the sensor unit 10 ends the measurement processing.

If a buffering mode setting command is received (Y in S116), the sensor unit 10 carries out measurement (acquires three-axis acceleration data and three-axis angular velocity data) at a predetermined sampling rate (S118).

Next, if the transmission buffer 152 (N-stage FIFO) is not full (N in S120), the sensor unit 10 writes the measured data acquired through the measurement in the process S118 into the transmission buffer 152 (N-stage FIFO) (S122). If the transmission buffer 152 (N-stage FIFO) is full (Y in S120), the sensor unit 10 writes the measured data acquired through the measurement in the process of S118 into the FIFO formed in the storage unit 16 (S124).

Next, if transmission is possible (Y in S126), the sensor unit 10 transmits the leading measured data in the transmission buffer 152 (N-stage FIFO) to the computing device (S128).

The sensor unit 10 repeats the processing of the processes S118 to S128 until a measurement end command or a real-time mode setting command is received from the computing device 20 (N in S130 and N in S132).

If a measurement end command is received (Y in S130), the sensor unit 10 ends the measurement processing.

If a real-time mode setting command is received (Y in S132), the sensor unit 10 carries out the processing of the process S102 and onward again.

In the flowchart of FIG. 8, the order of the processes may be changed suitably within a possible range.

### 1-1-4. Effects

As described above, according to the first embodiment, when the sensor unit 10 is in the real-time mode, a part of the measured data may be destroyed and may not be outputted. However, the output delay of the measured data can be reduced securely. Also, since the measured data only has small variation during the stationary period when there is little motion of the user 2, even if a part of the measured data is destroyed, the computing device 20 cane detect the stationary period on the basis of the remaining part of the measured data and can calculate the zero-point bias value using the measured data during the stationary period. Therefore, according to the embodiment, as the sensor unit 10 is in the real-time mode during the stationary period of the user 2, the computing device 20 can be used in reducing the time required for detecting the stationary period.

Also, in the embodiment, the sensor unit 10 in the buffering mode can output all of the measured data without destroying any, even if the output delay increases. Therefore, according to the embodiment, as the sensor unit 10 is set in the buffering mode during the swing action period of the user 2, the computing device 20 can acquire a sufficient volume of measured data during the swing action period of the user 2 and therefore can accurately analyze the swing motion by the user 2 on the basis of this measured data.

### 1-2. Second Embodiment

### 1-2-1. Outline of Motion Measurement System

A motion measurement system 1 according to a second embodiment includes a sensor unit 10 and a computing device 20, as in the first embodiment. In the second embodiment, the sensor unit 10 performs measurement at a first sampling rate (for example, 250 Hz) when set in the real-time mode, and performs measurement at a second sampling rate (for example, 1 kHz) when set in the buffering mode.

Specifically, in the second embodiment, in response to the measurement start operation by the user 2 in S1 of FIG. 3, the sensor unit 10 starts measurement at a first sampling rate. Then, during the stationary period when the user is stationary in S3 of FIG. 3 (an example of the stationary period of the measurement target), the sensor unit 10 carries out measurement at the first sampling rate and transmits measured data (an example of the first measured data) in the real-time mode to the computing device 20 (an example of the first measured data output process).

The computing device 20 receives the measured data measured at the first sampling rate, and detects a predetermined stationary period (for example, a stationary period of one second) of the user 2 on the basis of this measured data (an example of the stationary period detection process). If the stationary period of the user 2 is detected, the computing device 20 transmits a high rate and buffering mode setting command instructing the sensor unit 10 to switch to a second sampling rate and the buffering mode (an example of the first switch signal), to the sensor unit 10 (an example of the first switch signal transmission process).

The sensor unit 10 receives the high rate and buffering mode setting command and then switches the sampling rate to the second sampling rate and switches the output mode to the buffering mode on the basis of this command (an example of the first sampling rate switching process). Then, the sensor unit 10 carries out measurement at the second sampling rate during the period of the swing action by the user 2 in S5 of FIG. 3 (an example of the motion period of the measurement target) and transmits measured data (an example of the second measured data) in the buffering mode to the computing device 20 (an example of the second measured data output process).

The computing device 20 receives the measured data measured at the second sampling rate and analyzes the swing motion by the user 2, using this measured data (an example of the motion analysis process).

Moreover, the computing device 20 receives the measured data measured at the second sampling rate and detects the end of the swing motion by the user 2 (an example of the motion end detection process). If the end of the swing motion by the user 2 is detected, the computing device 20 transmits a low rate and real-time mode setting command instructing the sensor unit 10 to switch to the first sampling rate and the real-time mode (an example of the second switch signal), to the sensor unit 10 (an example of the second switch signal transmission process).

The sensor unit 10 receives the low rate and real-time mode setting command, and then switches the sampling rate to the first sampling rate and switches the output mode to the real-time mode on the basis of the command (an example of the second sampling rate switching process).

### 1-2-2. Configuration of Motion Measurement System

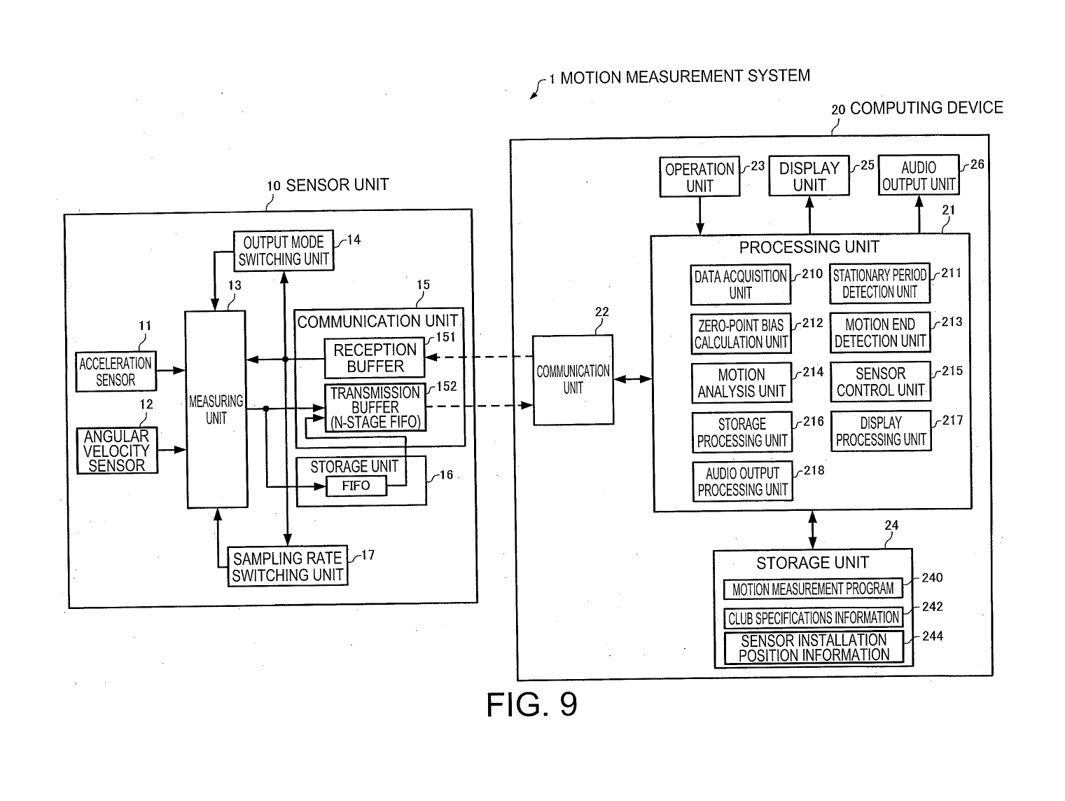

FIG. 9 shows an example of the configuration of the motion measurement system 1 (an example of the configuration of the sensor unit 10 and the computing device 20) according to the second embodiment. In FIG. 9, the components similar to those in FIG. 5 are denoted by the same reference numbers. The same descriptions as in the first embodiment are omitted or simplified below.

The sensor unit 10 in the second embodiment includes the same components as in the first embodiment and further includes a sampling rate switching unit 17.

The sampling rate switching unit 17 switches the sampling rate at which the measuring unit 13 carries out measurement (acquires three-axis acceleration data and three-axis angular velocity data). In this embodiment, if the measuring unit 13 receives a measurement start command from the communication unit 15, the measuring unit 13 starts measurement at the first sampling rate (for example, 250 Hz). Then, if the sampling rate switching unit 17 receives a high rate and buffering mode setting command from the communication unit 15, the sampling rate switching unit 17 switches the sampling rate of the measuring unit 13 to the second sampling rate (for example, 1 kHz). If the sampling rate switching unit 17 receives a low rate and real-time mode setting command from the communication unit 15, the sampling rate switching unit 17 switches the sampling rate of the measuring unit 13 to the first sampling rate.

The configuration of the computing device 20 in the second embodiment is similar to the first embodiment. However, the function of the sensor control unit 215 in the processing unit 21 is different from the first embodiment.

If the stationary period detection unit 211 detects the stationary period, the sensor control unit 215 in the second embodiment generates a high rate and buffering mode setting command and sends this command to the communication unit 22. If the motion end detection unit 213 detects the end of the swing motion by the user 2, the sensor control unit 215 generates a low rate and real-time mode setting command and sends this command to the communication unit 22.

If the sensor control unit 215 in the second embodiment receives operation data corresponding to a measurement start operation from the operation unit 23, the sensor control unit 215 generates a measurement start command and sends this command to the communication unit 22, as in the first embodiment. If the sensor control unit 215 receives operation data corresponding to a measurement end operation from the operation unit 23, the sensor control unit 215 generates a measurement end command and sends this command to the communication unit 22.

In the second embodiment, the stationary period detection unit 211 detects the stationary period when the user 2 is stationary, on the basis of the measured data measured by the sensor unit 10 at the first sampling rate. The motion end detection unit 213 detects the end of the swing motion by the user 2 on the basis of the measured data measured by the sensor unit 10 at the second sampling rate. The motion analysis unit 214 analyzes the swing motion by the user 2, using the measured data measured by the sensor unit 10 at the second sampling rate.

### 1-2-3. Processing in Motion Measurement System Time Chart

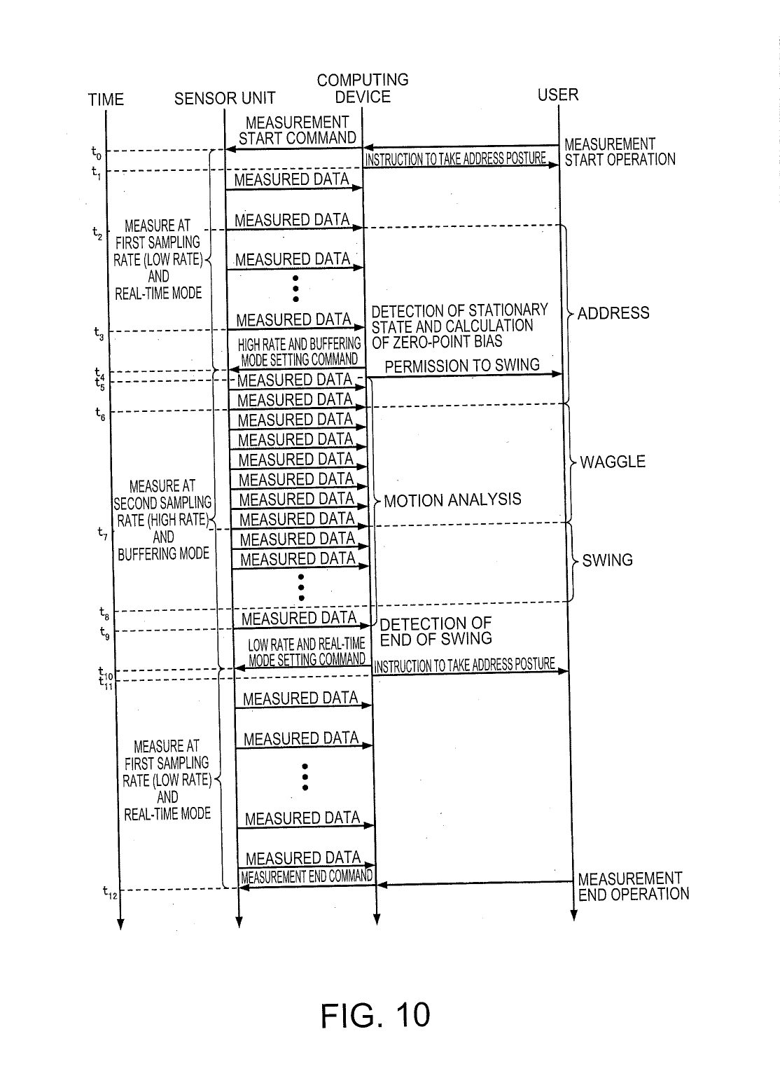

FIG. 10 shows an example of a time chart of actions by the user 2, processing by the sensor unit 10 and processing by the computing device 20 in the second embodiment. In the example of FIG. 10, at a time t₀, the computing device 20 transmits a measurement start command to the sensor unit 10 in response to a measurement start operation carried out by the user 2. The sensor unit 10 receives the measurement start command, then starts measurement at the first sampling rate (low rate), and transmits measured data successively to the computing device 20, in the real-time mode.

At a time t₁, the computing device 20 gives the user 2 a notification instructing the user 2 to take an address posture. The user 2, receiving this notification, becomes stationary in the address posture from a time t₂ onward.

At a time t₃, the computing device 20 detects a predetermined stationary period and performs zero-point bias calculation using the measured data measured at the first sampling rate (low rate) during the stationary period.

At a time t₄, the computing device 20 transmits a high rate and buffering mode setting command to the sensor unit 10. The sensor unit 10 receives the high rate and buffering mode setting command, then switches to measurement at the second sampling rate (high rate), and transmits measured data successively to the computing device 20, in the buffering mode.

At a time t₅, the computing device 20 gives the user 2 a notification permitting the user 2 to swing. The user 2, receiving this notification, performs a waggle from a time t₆ onward and then performs a swing action (backswing, downswing, and follow-through) during the period from a time t₇ to a time t₈.

The computing device 20 analyzes the swing motion, using the measured data measured at the second sampling rate (high rate), and detects the end of the swing action at a time t₉.

At a time t₁₀, the computing device 20 transmits a low rate and real-time mode setting command to the sensor unit 10. The sensor unit 10 receives the low rate and real-time mode setting command, then switches to measurement at the first sampling rate (low rate), and transmits measured data successively to the computing device 20, in the real-time mode.

At a time t₁₁, the computing device 20 gives the user 2 a notification instructing the user 2 to take an address posture.

At the time t₁₁ and onward, the user 2 may repeat the series of actions (address, waggle, and swing) similar to that carried out at the times t₂ to t₈. The sensor unit 10 and the computing device 20 repeat the processing similar to that carried out at the times t₂ to t₁₁, according to each action of the series of actions by the user 2.

Subsequently, at a time t₁₂, in response to a measurement end operation carried out by the user 2, the computing device 20 transmits a measurement end command to the sensor unit 10 and ends the processing. The sensor unit 10 receives the measurement end command and ends the measurement.

In the second embodiment, during the period when the user 2 is stationary in the address posture, the sampling rate is set to the first sampling rate and the output mode is set to the real-time mode in the sensor unit 10. Here, if the first sampling rate is set to or below the output rate at which the sensor unit 10 outputs measured data (transmission rate of measured data from the sensor unit 10 to the computing device 20), the transmission buffer 152 (N-stage FIFO) does not easily become full and therefore the measured data can be transmitted as much as possible without being destroyed. Also, the computing device 20 calculates the zero-point bias value using the measured data during the stationary period. Since there is only small variation in the measured data during the period when the user 2 is stationary, a small number of pieces of measured data may be enough. Therefore, it is preferable to set the first sampling rate to be as low as possible within a range such that the computing device 20 does not make an error in detecting the stationary period.

Also, during the swing action by the user 2 (times t₇ to t₈ in FIG. 10), the sampling rate is set to the second sampling rate and the output mode is set to the buffering mode in the sensor unit 10. Since there is large variation in the measured data during the swing action by the user 2 (times t₇ to t₈ in FIG. 10), it is better that the second sampling rate is higher in order to perform accurate motion analysis. Also, since the need for the computing device 20 to receive measured data in real time without any delay is not high during the swing action by the user 2, the second sampling rate may be set to be higher than the output rate of the sensor unit 10 (transmission rate of measured data from the sensor unit 10 to the computing device 20).

In view of such circumstances, in the second embodiment, the first sampling rate is set to be lower than the second sampling rate. For example, if the output rate (transmission rate) of the sensor unit 10 is 500 Hz, the first sampling rate may be set to 250 Hz or below (half the output rate (transmission rate) or below) and the second sampling rate may be set to 1 kHz or above (twice the output rate (transmission rate) or above). With such settings, during the period when the user 2 is stationary in the address posture, the computing device 20 can detect the stationary period in real time while the measured data that is destroyed is minimized, even if retransmission of measured data occurs to a certain extent because of a transmission error or the like. During the swing action by the user 2, the computing device 20 can acquire larger number of pieces of measured data and thus perform accurate motion analysis.

### Processing Procedures by Computing Device

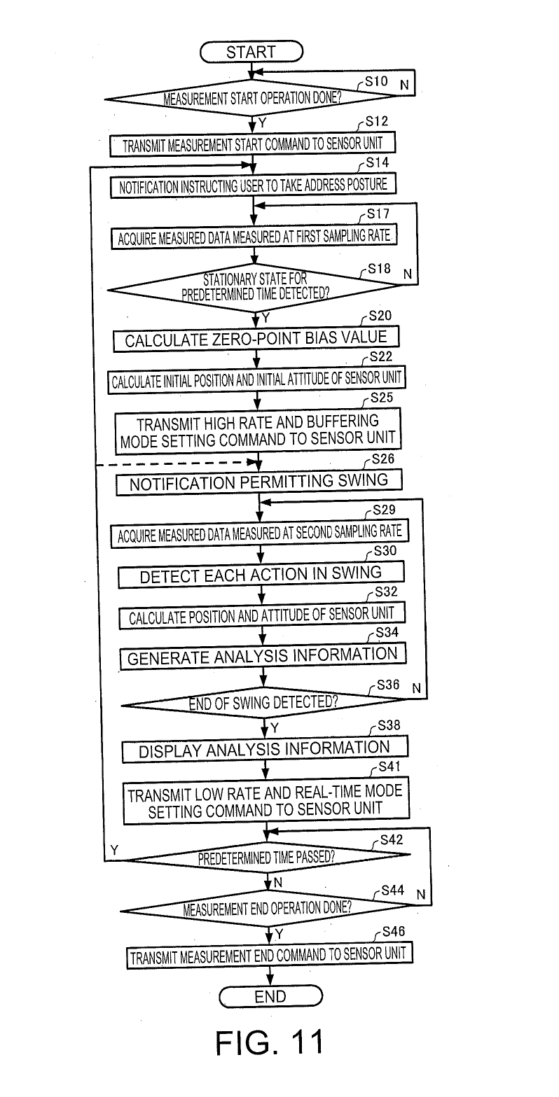

FIG. 11 is a flowchart showing procedures of motion measurement processing by the processing unit 21 of the computing device 20 in the second embodiment. In FIG. 11, the processes in which the same processing as in FIG. 7 is carried out are denoted by the same reference numbers. The processing unit 21 of the computing device 20 (an example of a computer) executes the motion measurement program 240 stored in the storage unit 24 and thereby executes the motion measurement processing according to the procedures in the flowchart of FIG. 11. Hereinafter, the flowchart of FIG. 11 will be described mainly in terms of the different processing from the flowchart of FIG. 7.

First, the processing unit 21 waits until a measurement start operation is carried out by the user 2 (N in S10). If a measurement start operation is carried out (Y in S10), the processing unit 21 carries out the processing of the processes S12 and S14, as in the first embodiment (FIG. 7).

Next, the processing unit 21 acquires measured data measured by the sensor unit 10 at the first sampling rate (S17).

Next, the processing unit 21 carries out the processing of the processes S18 to S22, as in the first embodiment (FIG. 7).

Next, the processing unit 21 transmits a high rate and buffering mode setting command to the sensor unit 10 via the communication unit 22 (S25).

Next, the processing unit 21 carries out the processing of the process S26, as in the first embodiment (FIG. 7).

Next, the processing unit 21 acquires measured data measured by the sensor unit 10 at the second sampling rate (S29).

Next, the processing unit 21 carries out the processing of the processes S30 to S38, as in the first embodiment (FIG. 7).

Next, the processing unit 21 transmits a low rate and real-time mode setting command to the sensor unit 10 via the communication unit 22 (S41).

Then, if a measurement end operation is not carried out by the user 2 before a predetermined time passes (Y in S42), the processing unit 21 carries out the processing of the processes S14 to S41 again (or may carry out the processing of the processes S26 to S41).

Meanwhile, if a measurement end operation is carried out by the user 2 before a predetermined time passes (N in S42 and Y in S44), the processing unit 21 transmits a measurement end command to the sensor unit 10 via the communication unit (S46) and ends the processing.

In the flowchart of FIG. 11, the order of the processes may be changed suitably within a possible range.

### Processing Procedures by Sensor Unit

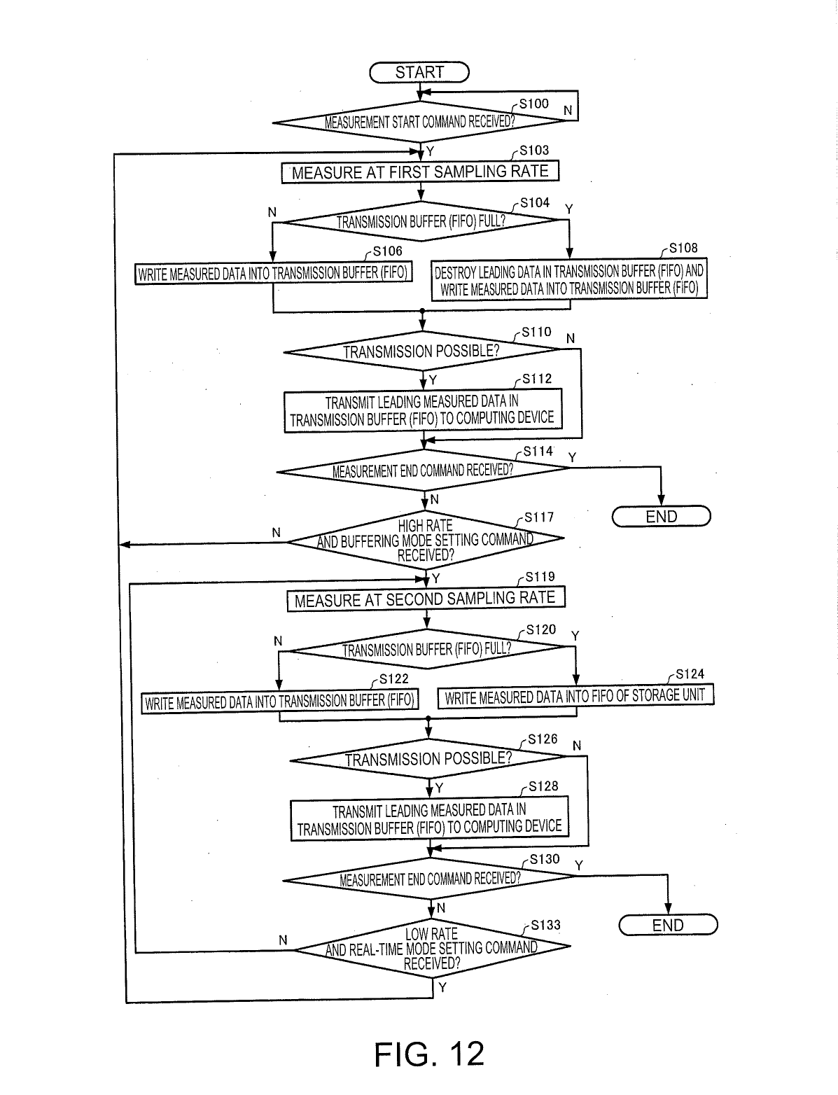

FIG. 12 is a flowchart showing procedures of measurement processing by the sensor unit 10 in the second embodiment. In FIG. 12, the processes in which the same processing as in FIG. 8 is carried out are denoted by the same reference numbers. Hereinafter, the flowchart of FIG. 12 will be described mainly in terms of the different processing from the flowchart of FIG. 8.

First, the sensor unit 10 waits until a measurement start command is received from the computing device 20 (N in S100). If a measurement start command is received (Y in S100), the sensor unit 10 carries out measurement (acquires three-axis acceleration data and three-axis angular velocity data) at the first sampling rate (S103).

Next, the sensor unit 10 carries out the processing of the processes S104 to S112, as in the first embodiment (FIG. 8).

The sensor unit 10 repeats the processing of the processes S103 to S112 until a measurement end command or a high rate and buffering mode setting command is received from the computing device 20 (N in S114 and N in S117).

Then, if a measurement end command is received (Y in S114), the sensor unit 10 ends the measurement processing.

If a high rate and buffering mode setting command is received (Y in S117), the sensor unit 10 carries out measurement (acquires three-axis acceleration data and three-axis angular velocity data) at the second sampling rate (S119).

Next, the sensor unit 10 carries out the processing of the processes S120 to S128, as in the first embodiment (FIG. 8).

The sensor unit 10 repeats the processing of the processes S119 to S128 until a measurement end command or a low rate and real-time mode setting command is received from the computing device 20 (N in S130 and N in S133).

If a measurement end command is received (Y in S130), the sensor unit 10 ends the measurement processing.

If a low rate and real-time mode setting command is received (Y in S133), the sensor unit 10 carries out the processing of the process S103 and onward again.

In the flowchart of FIG. 12, the order of the processes may be changed suitably within a possible range.

### 1-2-4. Effects

The second embodiment described above can achieve the effects similar to those of the first embodiment. Also, since the sampling rate of the sensor unit 10 (first sampling rate) is set to be lower than in the first embodiment during the stationary period of the user 2, the measured data that is destroyed without being transmitted to the computing device 20 can be reduced. Moreover, since the sampling rate of the sensor unit 10 (second sampling rate) is set to be higher than in the first embodiment during the period of the swing action by the user 2, the computing device 20 can analyze the swing motion by the user 2 more accurately.

### 1-3. Third Embodiment

### 1-3-1. Outline of Motion Measurement System

A motion measurement system 1 according to a third embodiment includes a sensor unit 10 and a computing device 20, as in the first embodiment. In the third embodiment, the sensor unit 10 performs measurement at a predetermined sampling rate (for example, 1 kHz). When the output mode is the real-time mode, the sensor unit 10 detects a high-speed action by the user 2 on the basis of the measured data and switches the output mode to the buffering mode. Meanwhile, when the output mode is the buffering mode, the sensor unit 10 detects a low-speed action by the user 2 on the basis of the measured data and switches the output mode to the real-time mode.

Specifically, in the third embodiment, in response to the measurement start operation by the user 2 in S1 of FIG. 3, the sensor unit 10 starts measurement at a predetermined sampling rate. Then, during the stationary period when the user is stationary in S3 of FIG. 3 (an example of the stationary period of the measurement target), the sensor unit 10 outputs measured data (an example of the first measured data) in the real-time mode and transmits the measured data to the computing device 20 (an example of the first measured data output process).

The computing device 20 receives the measured data and detects a predetermined stationary period (for example, a stationary period of one second) of the user 2 on the basis of this measured data (an example of the stationary period detection process).

On the basis of the measured data, the sensor unit 10 detects a high-speed action (for example, a swing start action) in the swing action by the user in S5 of FIG. 3. On the basis of this detection signal (an example of the first switch signal), the sensor unit 10 switches the output mode to the buffering mode (an example of the first output mode switching process). Then, during the period of the swing action by the user 2 in S5 of FIG. 3 (an example of the motion period of the measurement target), the sensor unit 10 transmits measured data (an example of the second measured data) in the buffering mode to the computing device 20 (an example of the second measured data output process).

The computing device 20 receives the measured data and analyzes the swing motion by the user 2, using this measured data (an example of the motion analysis process).

On the basis of the measured data, the sensor unit 10 detects a low-speed action (for example, a stationary state) after the end of the swing action by the user in S5 of FIG. 3. On the basis of this detection signal (an example of the second switch signal), the sensor unit 10 switches the output mode to the real-time mode (an example of the second output mode switching process).

### 1-3-2. Configuration of Motion Measurement System

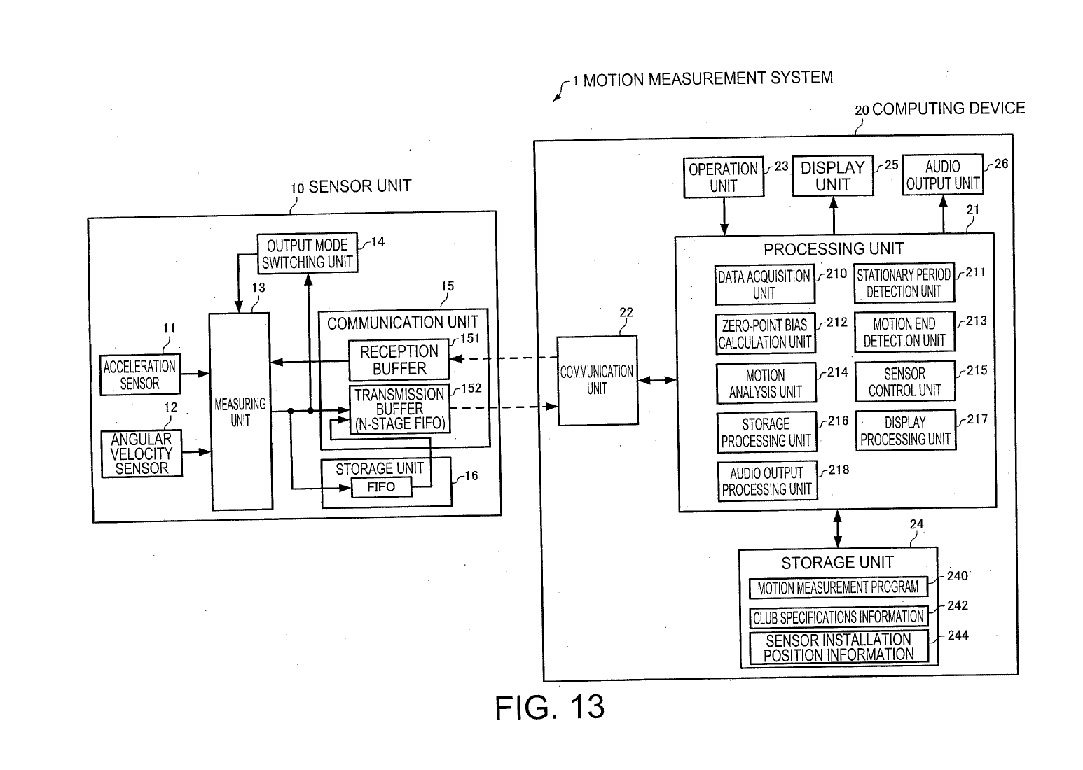

FIG. 13 shows an example of the configuration of the motion measurement system 1 (an example of the configuration of the sensor unit 10 and the computing device 20) according to the third embodiment. In FIG. 13, the components similar to those in FIG. 5 are denoted by the same reference numbers. The same descriptions as in the first embodiment are omitted or simplified below.

The configuration of the sensor unit 10 in the third embodiment includes the same components as in the first embodiment. However, the configuration of the output mode switching unit 14 is different from the first embodiment.

The output mode switching unit 14 switches the output mode in which the measured data measured by the measuring unit 13 is outputted outside. Specifically, when the output mode is the real-time mode, the output mode switching unit 14 detects a high-speed action by the user 2 and switches the output mode to the buffering mode, if the amount of change in the measured data generated by the measuring unit 13 (for example, a combined value of three-axis acceleration data or a combined value of three-axis angular velocity data) is equal to or above a first threshold. Meanwhile, when the output mode is the buffering mode, the output mode switching unit 14 detects a low-speed action by the user 2 and switches the output mode to the real-time mode, if the amount of change in the measured data generated by the measuring unit 13 is equal to or below a second threshold.

The configuration of the computing device 20 in the third embodiment is similar to the first embodiment. However, the function of the sensor control unit 215 in the processing unit 21 is different from the first embodiment.

If the sensor control unit 215 in the third embodiment receives operation data corresponding to a measurement start operation from the operation unit 23, the sensor control unit 215 generates a measurement start command and sends this command to the communication unit 22, as in the first embodiment. If the sensor control unit 215 receives operation data corresponding to a measurement end operation from the operation unit 23, the sensor control unit 215 generates a measurement end command and sends this command to the communication unit 22. Unlike that of the first embodiment, the sensor control unit 215 in the third embodiment does not carryout the processing of generating a buffering mode setting command or a real-time mode setting command and sending the command to the communication unit 22.

### 1-3-3. Processing in Motion Measurement System Time Chart

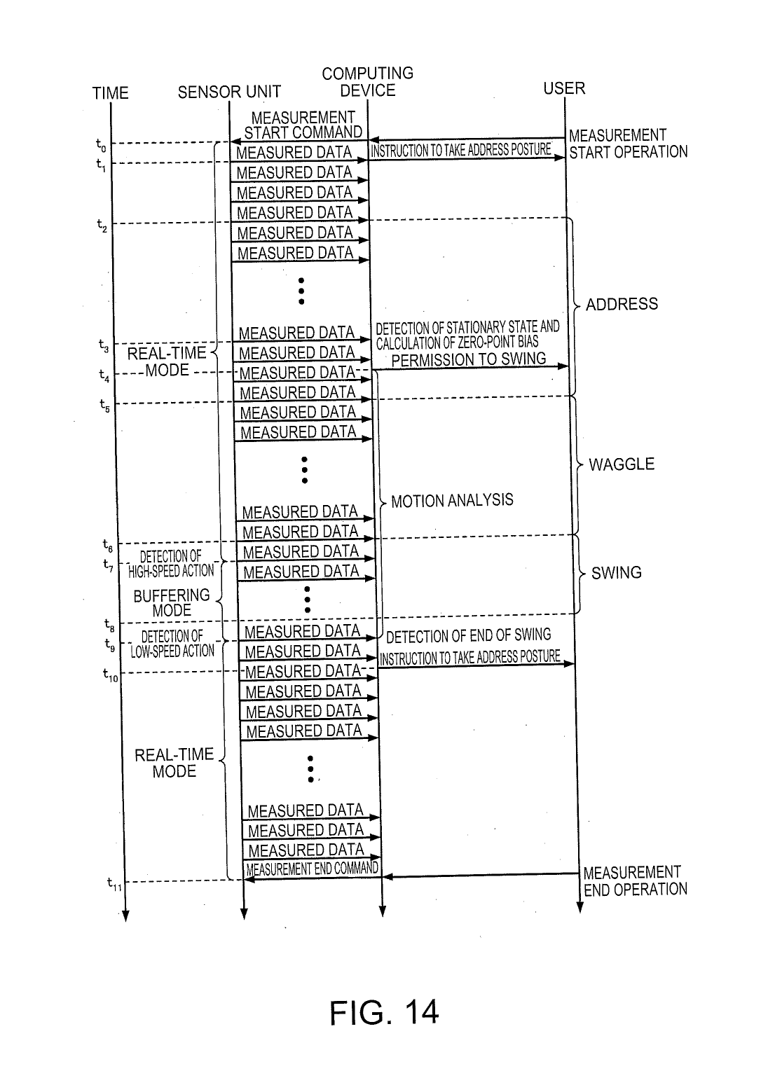

FIG. 14 shows an example of a time chart of actions by the user 2, processing by the sensor unit 10 and processing by the computing device 20 in the third embodiment. In the example of FIG. 14, at a time t₀, the computing device 20 transmits a measurement start command to the sensor unit 10 in response to a measurement start operation carried out by the user 2. The sensor unit 10 receives the measurement start command, then starts measurement at a predetermined sampling rate, and transmits measured data successively to the computing device 20, in the real-time mode.

At a time t₁, the computing device 20 gives the user 2 a notification instructing the user 2 to take an address posture. The user 2, receiving this notification, becomes stationary in the address posture from a time t₂ onward.

At a time t₃, the computing device 20 detects a predetermined stationary period and performs zero-point bias calculation using the measured data measured during the stationary period.

At a time t₄, the computing device 20 gives the user 2 a notification permitting the user 2 to swing. The user 2, receiving this notification, performs a waggle from a time t₅ onward and then performs a swing action (backswing, downswing, and follow-through) during the period from a time t₆ to a time t₈.

At a time t₇, the sensor unit 10 detects a high-speed action by the user 2, then switches the output mode to the buffering mode, and transmits measured data successively to the computing device 20, in the buffering mode.

The computing device 20 analyzes the swing motion, using the measured data, and detects the end of the swing action at a time t₉.

Also, at the time t₉, the sensor unit 10 detects a low-speed action by the user 2, then switches the output mode to the real-time mode, and transmits measured data successively to the computing device 20, in the real-time mode.

At a time t₁₀, the computing device 20 gives the user 2 a notification instructing the user 2 to take an address posture.

At the time t₁₀ and onward, the user 2 may repeat the series of actions (address, waggle, and swing) similar to that carried out at the times t₂ to t₈. The sensor unit 10 and the computing device 20 repeat the processing similar to that carried out at the times t₂ to t₁₀, according to each action of the series of actions by the user 2.

Subsequently, at a time tₙ, in response to a measurement end operation carried out by the user 2, the computing device 20 transmits a measurement end command to the sensor unit 10 and ends the processing. The sensor unit 10 receives the measurement end command and ends the measurement.

In the third embodiment, the sensor unit 10 performs measurement at a predetermined sampling rate, and during the period when the user 2 is stationary in the address posture, the sensor unit 10 transmits measured data to the computing device 20 in the real-time mode. Therefore, the computing device 20 can detect the stationary period almost in real time. Therefore, the time during which the user 2 is stationary in the address posture (times t₂ to t₅ in FIG. 14) can be reduced securely and the convenience for the user 2 can be enhanced.

When the output mode is the real-time mode, the sensor unit 10 detects a high-speed action at the start of the swing action by the user 2, then switches the output mode to the buffering mode, and transmits measured data to the computing device 20 in the buffering mode. Therefore, during the swing action (times t₇ to t₉ in FIG. 14) except immediately after the start of the swing by the user 2, the sensor unit 10 can transmit a large number of pieces of measured data necessary for motion analysis to the computing device 20. Therefore, the computing device 20 can acquire the large number of pieces of measured data and thus perform accurate motion analysis.

### Processing Procedures by Computing Device

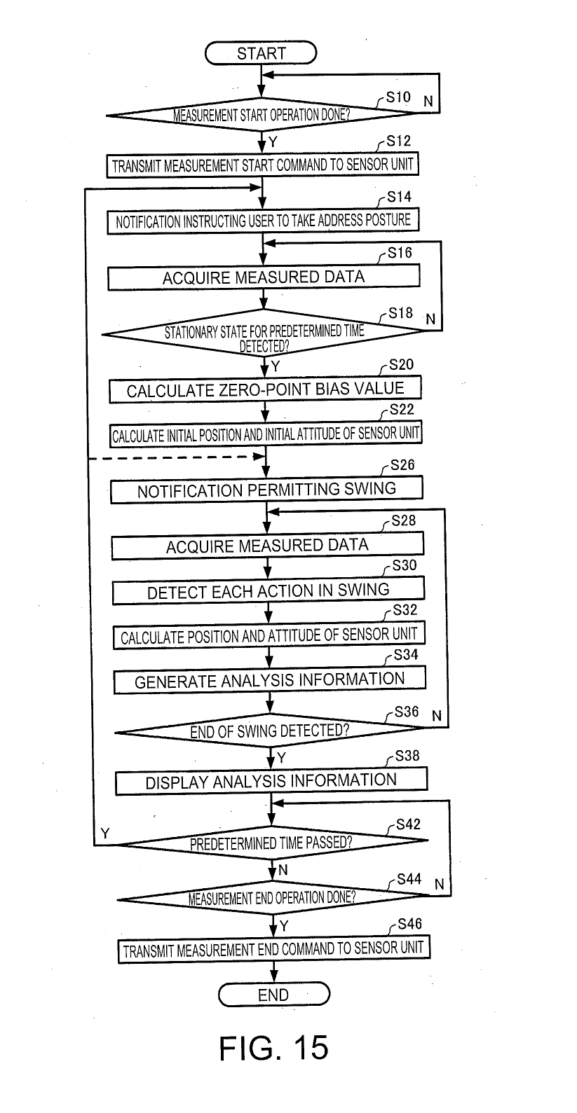

FIG. 15 is a flowchart showing procedures of motion measurement processing by the processing unit 21 of the computing device 20 in the third embodiment. In FIG. 15, the processes in which the same processing as in FIG. 7 is carried out are denoted by the same reference numbers. The processing unit 21 of the computing device 20 (an example of a computer) executes the motion measurement program 240 stored in the storage unit 24 and thereby executes the motion measurement processing according to the procedures in the flowchart of FIG. 15. Hereinafter, the flowchart of FIG. 15 will be described mainly in terms of the different processing from the flowchart of FIG. 7.

First, the processing unit 21 waits until a measurement start operation is carried out by the user 2 (N in S10). If a measurement start operation is carried out (Y in S10), the processing unit 21 carries out the processing of the processes S12 to S22, as in the first embodiment (FIG. 7). The processing unit 21 does not carry out the processing of the process S24 in the first embodiment (FIG. 7).

Next, the processing unit 21 carries out the processing of the processes S26 to S38, as in the first embodiment (FIG. 7). The processing unit 21 does not carry out the processing of the process S40 in the first embodiment (FIG. 7).

Then, if a measurement end operation is not carried out by the user 2 before a predetermined time passes (Y in S42), the processing unit 21 carries out the processing of the processes S14 to S38 again (or may carry out the processing of the processes S26 to S38).

Meanwhile, if a measurement end operation is carried out by the user 2 before a predetermined time passes (N in S42 and Y in S44), the processing unit 21 transmits a measurement end command to the sensor unit 10 via the communication unit (S46) and ends the processing.

In the flowchart of FIG. 15, the order of the processes may be changed suitably within a possible range.

### Processing Procedures by Sensor Unit

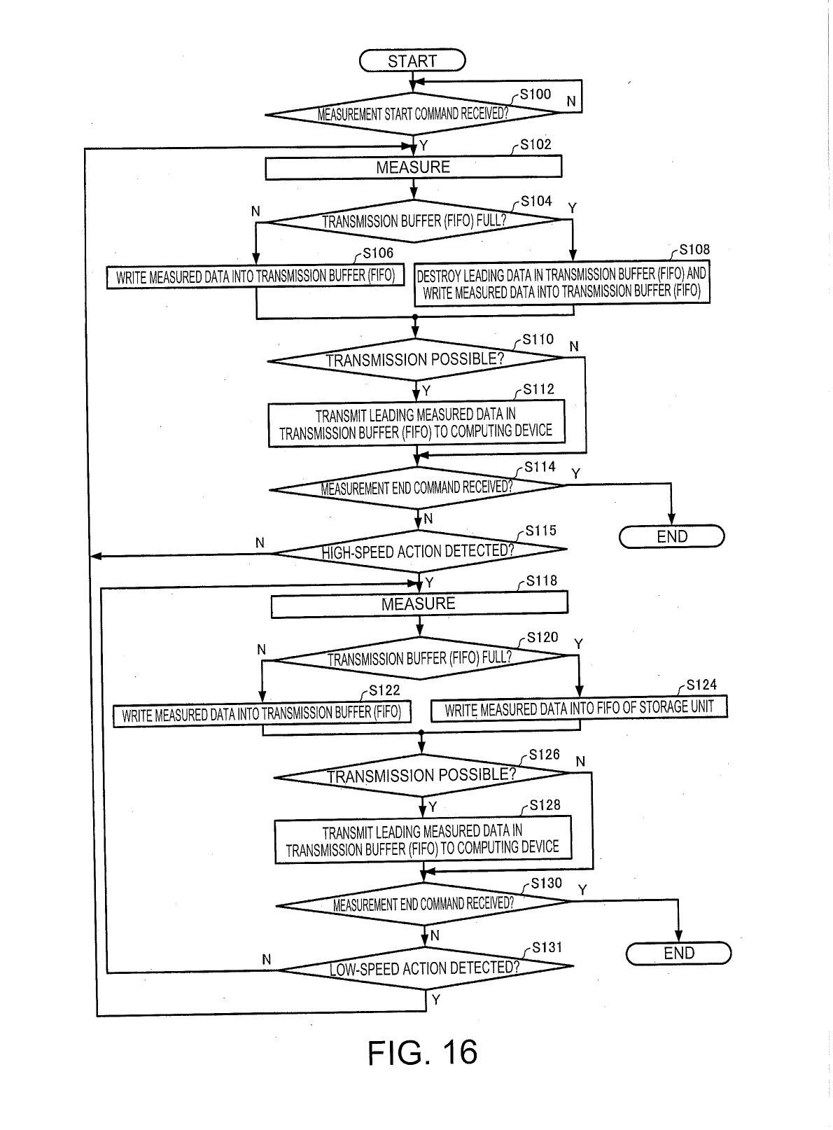

FIG. 16 is a flowchart showing procedures of measurement processing by the sensor unit 10 in the third embodiment. In FIG. 16, the processes in which the same processing as in FIG. 8 is carried out are denoted by the same reference numbers. Hereinafter, the flowchart of FIG. 16 will be described mainly in terms of the different processing from the flowchart of FIG. 8.

First, the sensor unit 10 waits until a measurement start command is received from the computing device 20 (N in S100). If a measurement start command is received (Y in S100), the sensor unit 10 carries out measurement (acquires three-axis acceleration data and three-axis angular velocity data) at a predetermined sampling rate (S102).

Next, the sensor unit 10 carries out the processing of the processes S104 to S112, as in the first embodiment (FIG. 8).

The sensor unit 10 repeats the processing of the processes S102 to S112 until a measurement end command is received from the computing device 20 or a high-speed action by the user 2 is detected (N in S114 and N in S115).

Then, if a measurement end command is received (Y in S114), the sensor unit 10 ends the measurement processing.

If a high-speed action by the user 2 is detected (Y in S115), the sensor unit 10 carries out the processing of the processes S118 to S128, as in the first embodiment (FIG. 8).

The sensor unit 10 repeats the processing of the processes S118 to S128 until a measurement end command is received from the computing device 20 or a low-speed action by the user 2 is detected (N in S130 and N in S131).

If a measurement end command is received (Y in S130), the sensor unit 10 ends the measurement processing.

If a low-speed action by the user 2 is detected (Y in S131), the sensor unit 10 carries out the processing of the process S102 and onward again.

In the flowchart of FIG. 16, the order of the processes may be changed suitably within a possible range.

### 1-3-4. Effects

The third embodiment described above can achieve the effects similar to those of the first embodiment. Also, since the sensor unit 10 automatically switches the output mode on the basis of the measured data, the processing load on the computing device 20 can be reduced, compared with the first embodiment.

### 2. Modifications

The invention is not limited to the embodiments and various modifications can be made within the scope of the invention.

For example, in the third embodiment, the sensor unit 10 decides the timing of switching the sampling rate on the basis of the amount of change in measured data. However, the sensor unit 10 may calculate the action speed of the user 2 on the basis of measured data and decide the timing of switching on the basis of the action speed. Also, the sensor unit 10 may change the sampling rate according to the range of the action speed of the user 2. For example, the sampling rate may be set to be higher as the action speed of the user 2 becomes higher.

In the third embodiment, the sensor unit 10 may switch the output mode to the buffering mode and switch the sampling rate to the second sampling rate if the sensor unit 10 detects a high-speed action by the user 2 on the basis of measured data, whereas the sensor unit 10 may switch the output mode to the real-time mode and switch the sampling rate to the first sampling rate if the sensor unit 10 detects a low-speed action by the user 2 on the basis of the measured data.

In each of the embodiments, the acceleration sensor 11 and the angular velocity sensor 12 are arranged as an integrated built-in unit in the sensor unit 10. However, the acceleration sensor 11 and the angular velocity sensor 12 may not be integrated. Alternatively, the acceleration sensor 11 and the angular velocity sensor 12 may be directly installed on the golf club 3 or the user 2, instead of arranged as a built-in unit in the sensor unit 10. Also, while the sensor unit 10 and the computing device 20 in the embodiments are separate units, these may be integrated and made installable on the golf club 3 or the user 2.

In each of the embodiments, a motion measurement system which measures swing motions in golf is employed as an example. However, the invention can also be applied to motion measurement systems which measure various swing motions in tennis, baseball and the like. The invention can also be applied to motion measurement systems which measure various motions other than swing motions.

In each of the embodiments, the swing motion by the user 2 is measured. That is, the user 2 is described as a measurement target. However, it can also be said that the motion of the golf club 3 is measured and therefore the golf club 3 may be considered as a measurement target. The invention can also be applied to arbitrary measurement targets which can become stationary and move, for example, sports equipment other than the golf club 3, and objects other than sports equipment.

The embodiments and modifications are examples and not limiting. For example, the embodiments and modifications can be suitably combined.

The invention includes configurations that are substantially the same as the configurations described in the embodiments (for example, configurations with the same functions, methods and results, or configurations with the same purposes and effects). The invention also includes the configurations described in the embodiments with any non-essential part replaced. The invention also includes configurations having the same advantages and effects as the configurations described in the embodiment, or configurations that can achieve the same purpose. Also, the invention includes the configurations described in the embodiment with a known technique added.

The entire disclosure of Japanese Patent Application No. 2014-197267, filed Sep. 26, 2014 is expressly incorporated by reference herein.

What is claimed is:

1. A sensor comprising:
a measuring unit;
a first buffer which saves measured data measured by the measuring unit;
a second buffer; and
an output mode switching unit which switches an output mode for outputting the measured data outside;
wherein the output mode includes
a first mode in which the first buffer is overwritten with the measured data if there is no free space in the first buffer, and
a second mode in which the measured data is written in the second buffer if there is no free space in the first buffer and in which the measured data written in the second buffer is transferred to the first buffer if a free space is generated in the first buffer.

2. The sensor according to claim 1, wherein
the output mode switching unit switches the output mode on the basis of a switch signal inputted from outside.

3. The sensor according to claim 1, wherein
the output mode switching unit switches the output mode on the basis of the measured data.

4. A motion measurement system comprising a sensor and a computing device,
the sensor comprising:
a measuring unit;
a first buffer which saves measured data measured by the measuring unit;
a second buffer; and
an output mode switching unit which switches an output mode for outputting the measured data outside,
the output mode including:
a first mode in which the first buffer is overwritten with the measured data if there is no free space in the first buffer; and
a second mode in which the measured data is written in the second buffer if there is no free space in the first buffer and in which the measured data written in the second buffer is transferred to the first buffer if a free space is generated in the first buffer,
the computing device including:
a stationary period detection unit which detects a stationary period during which a measurement target is stationary, on the basis of first measured data outputted from the sensor in the first mode; and
a sensor control unit which transmits, to the sensor, a first switch signal instructing the sensor to switch to the second mode, if the stationary period detection unit detects the stationary period.

5. The motion measurement system according to claim 4, wherein
in the computing device,
the stationary period detection unit detects the stationary period if the first measured data is within a predetermined range at a predetermined time.

6. The motion measurement system according to claim 4, wherein
the computing device includes a zero-point bias value calculation unit which calculates a zero-point bias value of the measured data from the sensor if the stationary period detection unit detects the stationary period.

7. The motion measurement system according to claim 4, wherein
the computing device includes a motion analysis unit which analyzes a motion of the measurement target, using second measured data outputted from the sensor in the second mode.

8. The motion measurement system according to claim 4, wherein
the computing device includes a motion end detection unit which detects an end of the motion of the measurement target, and
the sensor control unit transmits, to the sensor, a second switch signal instructing the sensor to switch to the first mode, if the motion end detection unit detects the end of the motion of the measurement target.

9. The motion measurement system according to claim 8, wherein
the sensor includes a sampling rate switching unit which switches a sampling rate at which the measuring unit carries out measurement,
in the computing device,
the stationary period detection unit detects the stationary period on the basis of the first measured data measured at a first sampling rate and outputted in the first mode by the sensor, and
the sensor control unit transmits, to the sensor, the first switching signal instructing the sensor to switch to a second sampling rate and switch to the second mode, if the stationary period detection unit detects the stationary period, and
the first sampling rate is lower than the second sampling rate.

10. The motion measurement system according to claim 9 wherein
in the computing device,
the sensor control unit transmits, to the sensor, the second switch signal instructing the sensor to switch to the first mode and switch to the first sampling rate, if the motion end detection unit detects the end of the motion of the measurement target.

11. A method of motion measurement comprising:
causing a sensor to output first measured data in a first mode, in a stationary period of a measurement target; and
causing the sensor to output second measured data in a second mode, in a motion period of the measurement target,
wherein the first mode is a mode in which, if there is no free space in a first buffer for saving the measured data when outputting the measured data outside, the first buffer is overwritten with the measured data, and
the second mode is a mode in which the measured data is written in a second buffer if there is no free space in the first buffer and in which the measured data written in the second buffer is transferred to the first buffer if a free space is generated in the first buffer.

12. A method of motion measurement comprising:
causing a sensor to output first measured data in a first mode, in a stationary period of a measurement target;
causing a computing device to detect the stationary period during which the measurement target is stationary, on the basis of the first measured data;
causing the computing device to transmit, to the sensor, a first switch signal instructing the sensor to switch to a second mode, if the stationary period is detected;
causing the sensor to switch the output mode to the second mode on the basis of the first switch signal; and
causing the sensor to output second measured data in the second mode,
wherein the first mode is a mode in which, if there is no free space in a first buffer for saving the measured data when outputting the measured data outside, the first buffer is overwritten with the measured data, and
the second mode is a mode in which the measured data is written in a second buffer if there is no free space in the first buffer and in which the measured data written in the second buffer is transferred to the first buffer if a free space is generated in the first buffer.

13. The method of motion measurement according to claim 12, wherein
in the causing a computing device to detect the stationary period, the computing device detects the stationary period when the first measured data is within a predetermined range at a predetermined time.

14. The method of motion measurement according to claim 12, further comprising
causing the computing device to calculate a zero-point bias value of the measured data from the sensor if the stationary period is detected.

15. The method of motion measurement according to claim 12, further comprising
causing the computing device to analyze the motion of the measurement target, using the second measured data.

16. The method of motion measurement according to claim 12, further comprising:
causing the computing device to detect an end of the motion of the measurement target; and
causing the computing device to transmit, to the sensor, a second switch signal instructing the sensor to switch to the first mode, if the end of the motion of the measurement target is detected.

17. The method of motion measurement according to claim 16, further comprising
causing the sensor to switch the output mode to the second mode on the basis of the second switch signal.
